(19) United States
(12) Patent Application Publication
(10) Pub. No.: US 2025/0160257 A1
(43) Pub. Date: May 22, 2025

(54) GRAIN CART MULTIPURPOSE DISPLAY AND RELATED METHODS

(71) Applicant: J. & M. Manufacturing Co., Inc., Ft. Recovery, OH (US)

(72) Inventors: Sean Kahlig, Ft. Recovery, OH (US); Mitchell J. Wood, Ft. Recovery, OH (US); Jason Kaiser, Ft. Recovery, OH (US); Ryan Kaiser, Ft. Recovery, OH (US); Michael Gaerke, Ft. Recovery, OH (US); Dustan Grieshop, Ft. Recovery, OH (US)

(21) Appl. No.: 18/947,492

(22) Filed: Nov. 14, 2024

Related U.S. Application Data
(60) Provisional application No. 63/599,589, filed on Nov. 16, 2023.

(51) Int. Cl. A01D 90/12; A01D 41/127

(52) U.S. Cl. CPC A01D 90/12; A01D 41/127

(57) ABSTRACT

An electronic display device including a visual display operably coupled to one or more sensors on a grain cart. The visual display is mounted on a grain transfer element of the grain cart. The visual display is configured to be viewable by an operator of the grain cart during a grain transfer operation. The visual is configured to display at least one of grain cart information or operating instructions.

### CROSS REFERENCE TO RELATED APPLICATIONS

This application claims the priority of U.S. Provisional Patent Application Ser. No. 63/599,589 filed on Nov. 16, 2023 (pending), the disclosure of which is incorporated herein by reference in its entirety.

This application is also generally related to the subject matter disclosed in U.S. Provisional Patent Application Ser. No. 63/065,352, filed on Aug. 13, 2020 (expired); U.S. Provisional Patent Application Ser. No. 63/091,024 (expired), filed on Oct. 13, 2020 (expired); PCT Application Serial No. PCT/US2021/045768, filed on Aug. 12, 2021 (expired); U.S. patent application Ser. No. 17/495,981, filed on Oct. 7, 2021 (pending); U.S. Provisional Patent Application Ser. No. 63/306,816, filed on Feb. 4, 2022 (expired); U.S. Provisional Application Ser. No. 63/310,451, filed on Feb. 15, 2022 (expired); PCT Application Serial No. PCT/US2023/012206,filed on Feb. 2, 2023 (expired); U.S. patent application Ser. No. 18/107,147, filed on Feb. 8, 2023 (pending); U.S. patent application Ser. No. 18/107,153, filed on Feb. 8, 2023 (pending); U.S. Provisional Patent Application Ser. No. 63/455,369, filed on Mar. 29, 2023 (expired); PCT Application Serial No. PCT/US2024/021991, filed on Mar. 28, 2024 (pending), and U.S. patent application Ser. No. 18/793,594, filed on Aug. 2, 2024 (pending), the disclosures of which are hereby incorporated by reference in their entirety.

### TECHNICAL FIELD

Embodiments relate generally to information displays for agricultural implements such as grain carts, seed tenders, and other agricultural implements, and related methods.

### BACKGROUND

Harvesting operations for some agricultural materials, such as corn, wheat, soybeans or similar grains, may involve transferring harvested grain into containers for transport. For example, a combine harvester may separate the grain from the other portions of the plant and may discharge the harvested grain into a container for transport. In some circumstances, the combine may discharge the harvested grain directly into a gravity wagon or a grain hopper trailer of a tractor-trailer for transport via roads. In other circumstances, the combine may discharge the harvested grain into a grain cart, which may be used to transport the grain across the field, such as to a road, where the grain cart is unloaded into a gravity wagon or a grain hopper trailer of a tractor-trailer for transport via roads.

Grain carts are usually pulled by a tractor for transporting grain from a harvesting combine in a field to an open top grain hopper trailer which transports the grain over the road to a grain elevator for drying and storage. Grain carts include a grain container, such as a grain tank, for holding the harvested grain and a grain transfer element, such as an unloading auger conveyor, for unloading the grain from the grain cart. Grain carts with only an unloading auger conveyor are commonly referred to as single auger carts. Dual auger carts include a horizontal auger located in the bottom of the grain container in addition to the unloading auger conveyor. On some grain carts, the grain transfer element extends upward from the bottom of the grain container and laterally outward, generally to the side of grain container. On other grain carts the grain transfer element extends upward from the bottom of the grain container, forward from a front wall of the grain container, and laterally outward from a side wall of the grain container. Grain carts with grain transfer elements oriented in this manner are often called corner auger grain carts due to the grain transfer element being generally aligned with and extending from a front corner portion of the grain container. Corner auger grain carts may be single or dual auger carts. By extending generally upwardly, laterally outwardly, and forwardly from the grain container, the grain transfer element may be conveniently viewed by the operator of the tractor and grain cart while unloading grain from the grain cart.

The grain in the grain tank of a grain cart is unloaded by using gravity to direct the grain into one or more openings in the bottom of the grain cart. In some grain carts, often referred to as single auger carts, the openings allow the grain to fall into the unloading auger conveyor. In other grain carts, often referred to as dual auger carts, the openings allow the grain to fall into a horizontal auger which directs the grain toward the unloading auger conveyor. Most grain carts have one or more moveable feed gates that cover the openings to the horizontal auger and/or unloading auger conveyor. The operator controls the position of the feed gates to control the area of the openings to control the amount of grain that is directed into the unloading auger conveyor. The unloading auger conveyor pushes the grain upward to a discharge spout which directs the grain into a container such as a grain hopper trailer, for example.

The horizontal and unloading augers are driven by a drive system powered off of the PTO or hydraulics of a tractor which causes the augers to rotate when the drive system is engaged or energized applying a torque to the augers. The torque required to rotate the augers increases if there is grain in the augers. The more grain that is present in the augers when the augers first start to rotate, the higher the initial torque in the drive system is. Generally, the highest torque a grain cart drive system will experience is when the augers first start to rotate while the augers are fully loaded with grain. Higher torques put greater stresses on the drive system components. If the drive system torque is high enough, a clutch in the driveline will slip preventing damage to the drive system, but also delaying the unloading of the grain. If the operator is unable to operate the unloading auger conveyor due to high torque, the operator will be forced to remove at least some grain from the augers, usually onto the ground, costing the farmer further time and money.

As stated above, the operator controls the position of the one or more feed gates to control the area of the one or more openings to control the amount of grain that is directed into the unloading auger conveyor. When the gates are closed, grain is prevented from entering the horizontal and/or unloading auger conveyor. This is desirable as it allows the operator to keep grain out of the augers, minimizing the torque required to start the rotation of the augers. Opening the gates allows the grain to be unloaded from the grain cart during a grain transfer operation. The further the gates are opened, the larger the openings to the augers which typically increases the discharge rate of the grain.

Grain carts equipped with feed gates usually include some method of indicating if the feed gates are fully opened, fully closed, or at some position in between. It is important for the operator to know the position of the feed gates. For example, the feed gates should be closed when not actively unloading and at the end of a grain transfer operation to “clean out” or empty the augers. Emptying the augers at the end of a grain transfer operation avoids undesirably high torque when starting the augers for the next grain transfer operation. Knowing how far open the feed gates are helps the operator control the rate at which the grain is unloaded or discharged. Opening the feed gates increases the discharge rate and closing the feed gates decreases the discharge rate.

In most instances, a feed gate position indicator is mechanically connected to the feed gate(s) and is visible on the front of the grain tank or the unloading auger conveyor. Examples of mechanical feed gate position indicators include: a rod extending from the front of the grain tank, a dial mounted on the front of the grain tank, a rod or cables connected to an indicator on the unloading auger conveyor. In other instances, the feed gate position indicator is a series one or two rows of individual LED lights on the unloading auger conveyor. All these feed gate position indicators have limited functionality.

During a grain transfer operation, the operator will focus their attention on the grain transfer element, specifically the upper portion of the unloading auger conveyor and discharge spout. At times the operator may look away from the grain transfer element during a grain transfer operation to view information related to the grain cart operation, such as scale readings, gate position, moisture readings, etc. While the operator is not looking at the grain transfer element there is increased chance that the discharged grain may miss the grain hopper trailer or overfill a portion of the trailer-each causing grain to spill onto the ground, for example. It would be advantageous if information related to the operation of the grain cart were visible to the operator before, during, and after a grain transfer operation without the operator having to divert their attention away from the grain transfer element to minimize the risk of spilling grain.

Accordingly, and despite the various advances already made in this field, there is a need for further improvements related to information displays for grain carts and other agricultural implements.

### SUMMARY

Generally, an electronic display device is provided. The electronic display device includes a visual display operably coupled to one or more sensors on a grain cart. The visual display is mounted on a grain transfer element of the grain cart. The visual display is configured to be viewable by an operator of the grain cart during a grain transfer operation. The visual display is configured to display at least one of grain cart information or operating instructions.

The visual display may be configured to display at least one of a rotational speed, a torque, or a horsepower. The visual display may be configured to display at least one of an unload rate, a moisture content, an unload time, a weight, an unloaded weight, a volume, or an unloaded volume. The visual display may be configured to display at least one of a remaining lubricant life, operating hours, or an unload count. The visual display may be configured to display at least one of a warning, an error code, a troubleshooting code, a troubleshooting instruction, a calibration instruction, a maintenance reminder, or contact information.

In alternative embodiments, the visual display may include at least one of an LED display, an E-INK display, a liquid crystal display (LCD), an incandescent display, a plasma display, a matrix display, or a multicolor display. The visual display may be configured to display at least one of letters, numbers, or symbols. The visual display may be programmable to display graphics or messages. The visual display may be configured to be used as a work light.

In some embodiments, at least one of the sensors may be a feed gate position sensor and the electronic display device may be operably coupled to the feed gate position sensor. The visual display may be configured to display a feed gate position. The visual display may be configured to display at least one of a direction the feed gate is moving, if the feed gate is opening or closing, if the feed gate is fully open or fully closed, or a percentage of the opening of the feed gate from 0% to 100%. The visual display may be configured to display a programmed feed gate position and to display the feed gate position relative to the programmed feed gate position. The visual display may be configured to display an error in at least one of an operation or function of a feed gate. The operating instructions may include at least one of positioning the feed gate, opening the feed gate, or closing the feed gate.

In alternative or additional aspects, at least one of the sensors may be a scale or load cell constructively configured to measure a weight of material in the grain cart and the electronic display device may be operably coupled to the scale or load cell. The visual display may be configured to display the weight of the material in the grain cart. The visual display may be configured to display a weight of material transferred to a receiving container. The operating instructions may include at least one of starting or stopping a grain transfer operation. The operating instructions may include at least one of increasing or decreasing a rotational speed.

In alternative or additional aspects, the visual display may be operably coupled to a sensor that may be constructively configured to detect the orientation of the visual display and the orientation of at least one of the grain cart information or the operating instructions displayed on the visual display may be based at least in part on an the detected orientation of the visual display.

In some embodiments, the electronic display device may include an auxiliary visual display operably coupled to the one or more sensors on the grain cart. The auxiliary visual display may be configured to be viewable by an operator of the grain cart during a grain transfer operation and to display at least one of grain cart information or operating instructions. The auxiliary visual display may be at least one of a tablet computer, a smartphone, a monitor, or a heads-up display. The auxiliary visual display may be mounted on a tractor. At least one of the sensors may be a feed gate position sensor. The electronic display device may be operably coupled to the feed gate position sensor. The auxiliary visual display may be configured to display a feed gate position. The auxiliary visual display may be configured to display at least one of a direction the feed gate is moving, if the feed gate is opening or closing, if the feed gate is fully open or fully closed, or a percentage of the opening of the feed gate from 0% to 100%. The auxiliary visual display may be configured to display a programmed feed gate position. The auxiliary visual display may be configured to display the feed gate position relative to the programmed feed gate position. The auxiliary visual display may be configured to display an error in at least one of an operation or function of a feed gate. The operating instructions may include at least one of positioning the feed gate, opening the feed gate, or closing the feed gate.

A grain cart is provided. The grain cart includes a grain cart container configured to hold grain, a grain transfer element, a feed gate, a feed gate position sensor, and an electronic display device. The grain transfer element is configured to transfer grain from the grain cart container to a receiving container. The feed gate is configured to selectively control a transfer rate of the grain. The feed gate position sensor configured to detect a position of the feed gate. The electronic display device is operatively coupled to the feed gate position sensor. The electronic display device includes a visual display mounted on the grain cart and configured to display a feed gate position and at least one of grain cart information or operating instructions. The visual display is viewable by an operator of the grain cart during a grain transfer operation.

In some embodiments, the visual display may mounted on the grain transfer element. The visual display may be configured to display at least one of a direction the feed gate is moving, if the feed gate is opening or closing, if the feed gate is fully open or fully closed, or a percentage of the opening of the feed gate from 0% to 100%. The visual display may be configured to display a programmed feed gate position and to display the feed gate position relative to the programmed feed gate position. The visual display may be configured to display an error in at least one of an operation or function of the feed gate. The visual display may be configured to display at least one of a rotational speed, a torque, or a horsepower. The visual display may be configured to display at least one of an unload rate, a moisture content, an unload time, a weight, an unloaded weight, a volume, or an unloaded volume. The visual display may be configured to display at least one of a remaining lubricant life, operating hours, a load count, or an unload count. The visual display may be configured to display at least one of a warning, an error code, a troubleshooting code, a troubleshooting instruction, a calibration instruction, a maintenance reminder, or contact information.

In alternative embodiments, visual display may include at least one of an LED display, an E-INK display, a liquid crystal display (LCD), an incandescent display, a plasma display, a matrix display, or a multicolor display. The visual display may be configured to display at least one of letters, numbers, or symbols. The visual display may be programmable to display graphics or messages. The visual display may be configured to be used as a work light.

In alternative or additional aspects, the grain cart may include a scale or load cell constructively configured to measure a weight of material in the grain cart and the electronic display device may be operably coupled to the scale or load cell. The visual display may be configured to display the weight of the material in the grain cart. The visual display may be configured to display a weight of material transferred to a receiving container.

In some embodiments, the operating instructions may include at least one of positioning the feed gate, opening the feed gate, or closing the feed gate. The operating instructions may include at least one of starting or stopping a grain transfer operation. The operating instructions may include at least one of increasing or decreasing a rotational speed. The operating instructions may include instructions for moving the grain cart to change the position of the grain transfer element relative to a receiving container. The visual display may be operably coupled to a sensor that may be constructively configured to detect the orientation of the visual display and the orientation of information displayed on the visual display may be based at least in part on the detected orientation of the visual display.

A method of operating an electronic display device with a visual display mounted on a grain transfer element of a grain cart is provided. The method includes detecting an operating condition of the grain cart and displaying information related to the detected operating condition on the visual display that is viewable by an operator of the grain cart during a grain transfer operation.

In alternative embodiments, the method may include displaying operating instructions. The method may include displaying at least one of a rotational speed, a torque, or a horsepower. The method may include displaying at least one of a an unload rate, a moisture content, an unload time, a weight, an unloaded weight, a volume, or an unloaded volume. The method may include displaying at least one of a remaining lubricant life, operating hours, or an unload count. The method may include displaying at least one of a warning, an error code, a troubleshooting code, a troubleshooting instruction, a calibration instruction, a maintenance reminder, or contact information.

A method of manufacturing an electronic display device is provided. The method includes providing a visual display configured to display grain cart information, operably coupling the visual display to a sensor, and mounting the visual display on a grain cart grain transfer element. When mounted, the visual display is viewable by an operator of the grain cart during a grain transfer operation.

In some embodiments, the visual display may be configured to display information related to a detected operating condition of the agricultural implement. The visual display may be configured to display at least one of a an unload rate, a moisture content, an unload time, a weight, an unloaded weight, a volume, or an unloaded volume. The visual display may be configured to display at least one of a rotational speed, a torque, or a horsepower. The visual display may be configured to display at least one of a remaining lubricant life, operating hours, or an unload count. The visual display may be configured to display at least one of a warning, an error code, a troubleshooting code, a troubleshooting instruction, a calibration instruction, a maintenance reminder, or contact information. The visual display may be configured to display operating instructions.

### BRIEF DESCRIPTION OF THE DRAWINGS

FIG. 1 is a perspective view of an illustrative dual auger corner auger grain cart, including an electronic display device with a visual display, coupled to a tractor and transferring harvested grain into a grain hopper trailer of a tractor-trailer.

FIG. 2 is a side view of the grain cart of FIG. 1.

FIG. 3 is a side sectional view of the grain cart of FIG. 1.

4A is a front view of the grain cart of FIG. 1 with a foldable upper auger portion of an unloading auger conveyor in a storage position.

FIG. 4B is a front view of the grain cart of FIG. 1 with the foldable upper auger portion of the unloading auger conveyor in a field position.

FIG. 4C is a front view of the grain cart of FIG. 1 with the foldable upper auger portion of the unloading auger conveyor in an unloading position.

FIG. 5 is a top view of the grain cart and tractor of FIG. 1.

FIGS. 6A and 6B are perspective views of an auxiliary visual display mounted in a tractor cab.

FIG. 7 is a simplified block diagram of an exemplary grain cart and electronic display device.

FIGS. 8A and 8B are sectional side views of an illustrative single auger corner auger grain cart.

FIGS. 9 through 11 illustrate a visual display in a feed gate position mode and providing a visual indication of the position of one or more grain cart feed gates.

FIGS. 12 through 17 illustrate a visual display in an alternative feed gate position mode and providing a visual indication of the positions of a plurality of grain cart feed gates.

FIGS. 18 through 22 illustrate a visual display in a feed gate target position mode and providing grain cart feed gate position feedback.

FIGS. 23 and 24 illustrate a visual display 202 in a gross grain weight mode and providing grain cart weight information.

FIGS. 25 and 26 illustrate a visual display in an unloaded grain weight mode and providing grain cart weight information.

FIGS. 27 through 30 illustrate a visual display in a grain cart position assist mode and providing grain cart positioning guidance.

FIGS. 31 through 32 illustrate a visual display in an end of unload summary mode and providing information about unloaded grain.

### DETAILED DESCRIPTION

Illustrative embodiments according to at least some aspects of the present disclosure are described and illustrated below and include devices, systems, and methods relating to transferring agricultural materials, such as grain, into receiving containers, including transport containers. The present disclosure includes, among other things, an electronic display device for displaying grain cart information to an operator and configured to be mounted on a grain transfer element. Some illustrative embodiments according to at least some aspects of the present disclosure are described below in the context of a grain cart and operations involving transferring grain from the grain cart to another container. It will be appreciated that similar devices, systems, and methods may be utilized in connection with other agricultural equipment and containers. As used herein, “transport container” may refer to any device configured to hold harvested grain during movement from one location to another location. Exemplary transport containers may include various types of agricultural equipment, such as grain carts, gravity wagons, grain tanks, grain hopper trailers for tractor-trailers, and the like. Transport containers may also include railcars configured to haul grain, barge or ship holds configured to haul grain, and the like. As used herein, “supplying container” may refer to a container from which grain is transferred and “receiving container” may refer to a container into which grain is transferred.

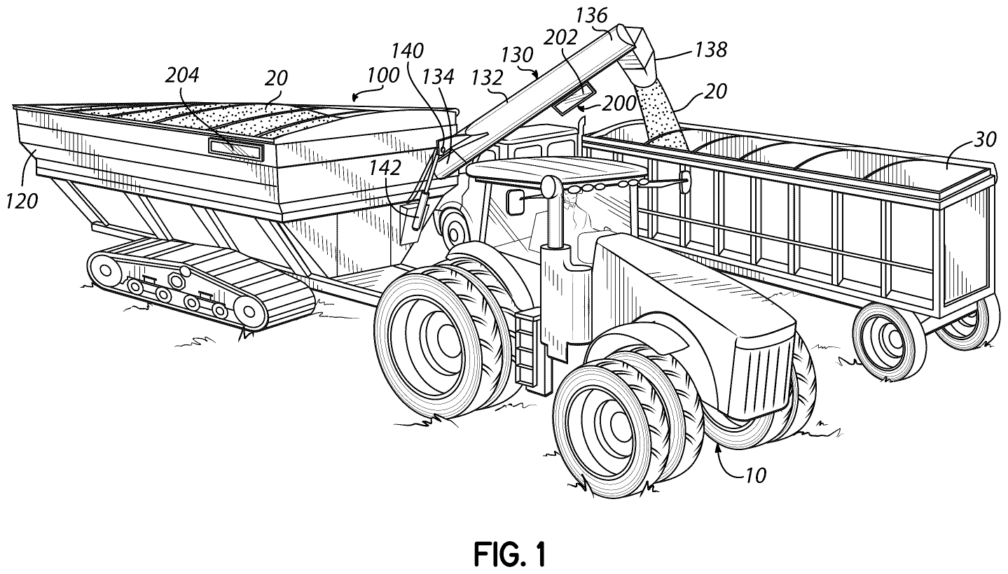

FIG. 1 is a perspective view of an illustrative dual auger corner auger grain cart 100 coupled to a tractor 10 transferring harvested grain 20 into a grain hopper trailer 30 of a tractor-trailer. The grain cart 100 includes a grain tank 120, a grain transfer element 130, and an electronic display device 200. The grain transfer element 130 includes an unloading auger conveyor 132 including a lower auger portion 134, a foldable upper auger portion 136, and a movable discharge spout 138. The grain transfer element 130 is configured to transfer grain from the grain cart grain tank 120 to a receiving container such as the grain hopper trailer 30, for example.

In this illustrative embodiment, the electronic display device 200 includes a visual display 202 mounted on the grain transfer element 130 and viewable by an operator in the cab of the tractor 10. Mounting the visual display 202 on the upper auger portion 134 of the grain transfer element 130, preferably on or near the discharge spout 138, enables an operator to view both the discharge spout 138 and the visual display 202 in a single field of view from the tractor cab during a grain transfer operation. The visual display 202 is configured to display grain cart information and operating instructions.

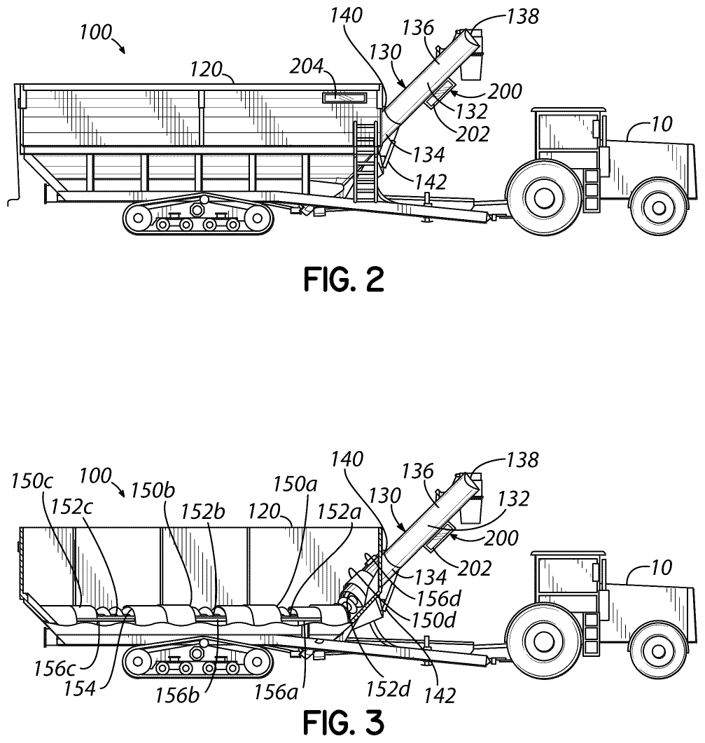

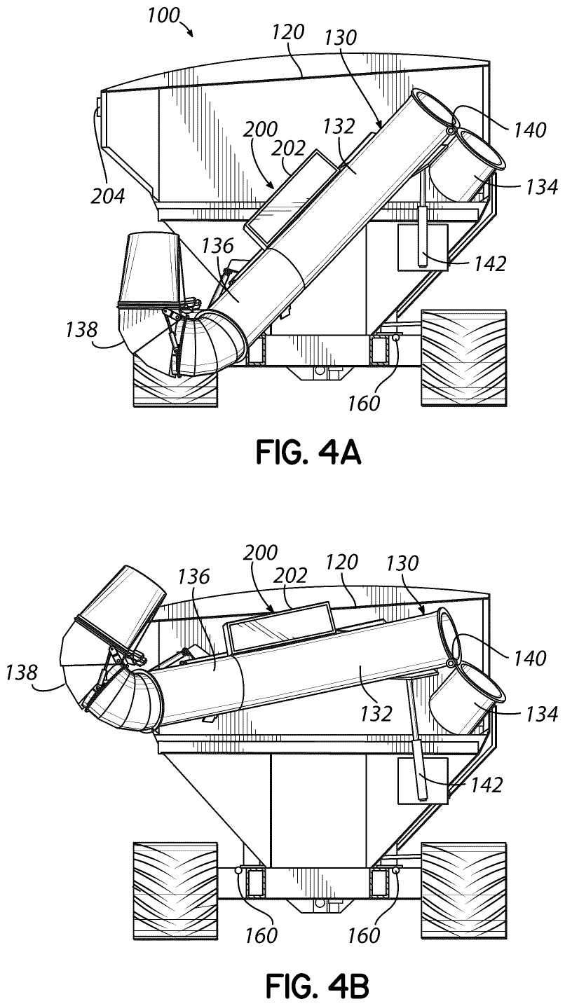

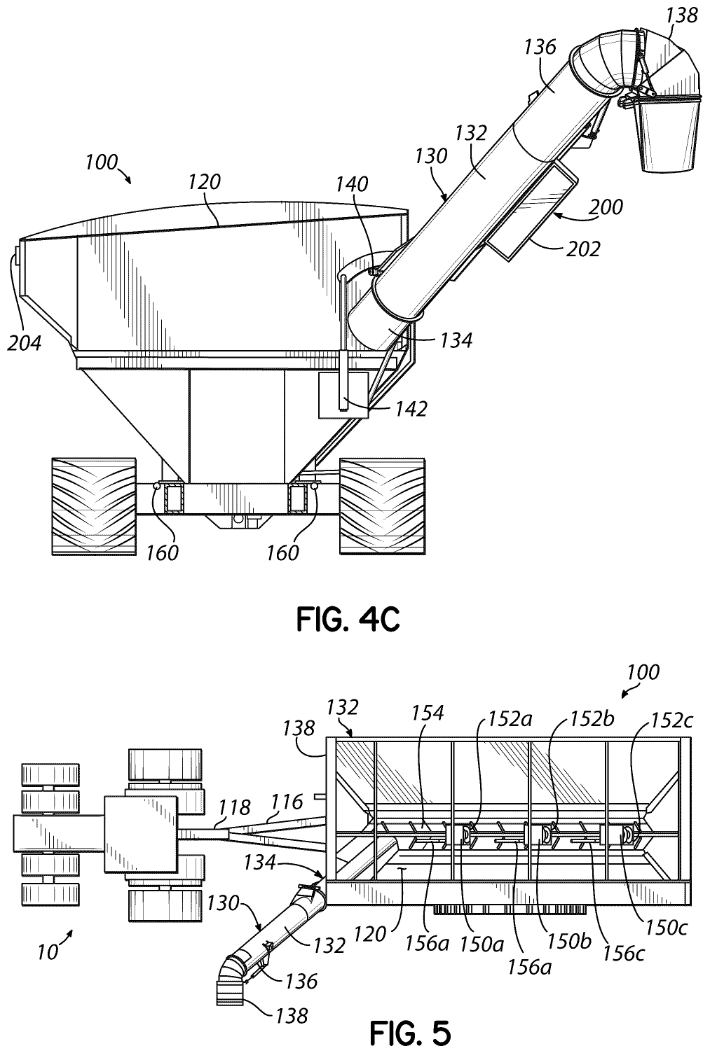

FIG. 2 is a side view of the grain cart 100 and FIG. 3 is a side sectional view of the grain cart 100. FIG. 4A is a front view of the grain cart 100 with the foldable upper auger portion 136 of the unloading auger conveyor 132 in a storage position. FIG. 4B is a front view of the grain cart 100 with the foldable upper auger portion 136 of the unloading auger conveyor 132 in a field position. FIG. 4C is a front view of the grain cart 100 with the foldable upper auger portion 136 of the unloading auger conveyor 132 in an unloading position. FIG. 5 is a top view of the grain cart 100 and tractor 10.

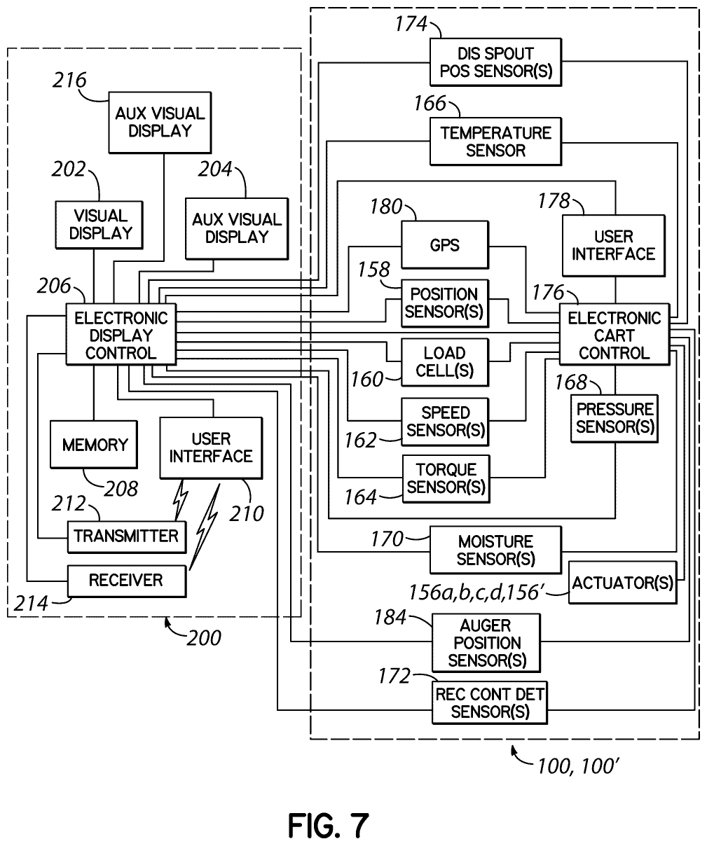

Referring to FIGS. 3 and 5, in this illustrative embodiment, the grain cart 100 includes first, second, and third movable feed gates 150a, 150b, 150c configured to cover respective first, second, and third openings 152a, 152b, 152c over a horizontal auger 154. It is understood that dual auger grain carts may have any number of feed gates and openings over a horizontal auger. The horizontal auger 154 is configured to push grain forward in the grain cart to the grain transfer element 130. The feed gates 150a, 150b, 150c are positioned by respective first, second, and third feed gate position actuators 156a, 156b, 156c. The actuators 156a, 156b, 156c are operatively coupled to the feed gates 150a, 150b, 150c and are configured to position the feed gates 150a, 150b, 150c between open and closed positions. In this illustrative embodiment, the actuators 156a, 156b, 156c are hydraulic cylinders. In alternate embodiments, the actuators 156a, 156b, 156c may be any combination of elements configured to position the feed gates 150a, 150b, 150c. One or more feed gate position sensors 158 detect the positions of the feed gates 150a, 150b, 150c as they open and close, see FIG. 7. The positions of the feed gates 150a, 150b, 150c determines how much of the openings 152a, 152b, 152c are uncovered which controls the amount of the grain going to the horizontal auger 154 and ultimately unloaded by the grain transfer element 130. In some dual auger grain carts, the grain transfer element 130 is mounted entirely outside the grain tank 120. In some dual auger grain carts, a portion of the lower auger portion 134 of the grain transfer element 130 may be inside the grain tank 120. In some embodiments, the grain cart 100 may include a feed gate 150d over an opening 152d in the lower auger portion 134. A feed gate position actuator 156d may be operatively coupled to the feed gate 150d and be configured to position the feed gate 150d between open and closed positions. Including a feed gate 150d on the lower auger portion 134 of the grain transfer element 130 of a dual auger grain cart may allow grain to be unloaded more evenly between the front and the back of the grain cart and at a faster unloading rate. Including a feed gate 150d on the lower auger portion 134 of the grain transfer element 130 of a dual auger grain cart may allow for a quicker cleanout at the end of an unloading operation.

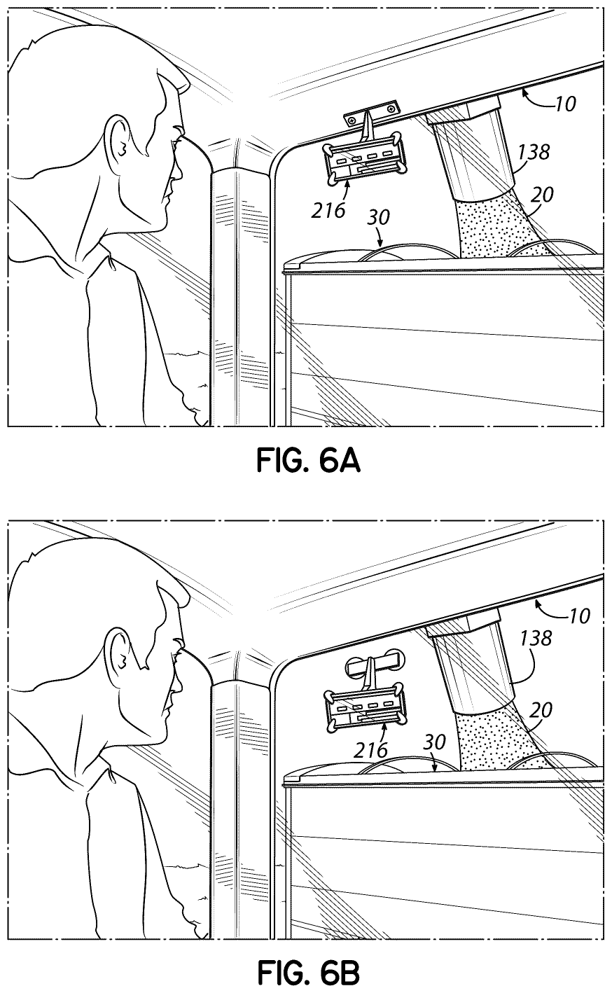

In some instances, a visual display 202 mounted on the grain transfer element 130 is easily viewable by an operator from the cab of a tractor while in other instances the visual display 202 may be partially or completely hidden from the operator's field of view, see FIG. 1. For example, due to the design of some tractor cabs and the orientation of the grain transfer element 130, the visual display 202 may be partially or completely hidden from the operator's field of view when the operator is sitting in a natural ergonomic position. The optimal location of the visual display 202 may depend not only on the tractor configuration, but also on the height of the operator, for example. A taller person may have a different perspective of the discharge spout 138 than a shorter person would. To see the visual display 202, a taller operator may need to bend down or over, for example, which may put the operator in an awkward position and will likely be a nuisance to the operator. FIGS. 6A and 6B illustrate an auxiliary visual display 216 mounted on a tractor inside of the tractor cab. In some embodiments, the auxiliary visual display 216 may be mounted on the tractor outside of the tractor cab, such as on an outside surface of a window, for example. In this illustrative embodiment, the operator has the option of locating the auxiliary visual display 216 according to their preference such that they can easily view the discharge spout 138 and the auxiliary visual display 216 in the same field of view, such as through a tractor cab window, for example. In other embodiments, the tractor may not have a cab and the auxiliary visual display 216 may be mounted anywhere that allows the operator to easily view the discharge spout 138 and the auxiliary visual display 216 at the same time. The auxiliary visual display 216 may include one or more brackets and/or mounting hardware configured to allow the auxiliary visual display 216 to be mounted in conveniently viewable locations. This is highly advantageous as the position of the operator relative to the discharge spout 138 is different for nearly every tractor.

Referring again to FIGS. 1, 6A, and 6B, the electronic display device 200 may include the auxiliary visual display 216 in addition to or instead of the visual display 202 mounted on the grain transfer element 130. The auxiliary visual display 216 may be configured to display the same information as the visual display 202. The auxiliary visual display 216 may be wired or wireless. In some embodiments, the auxiliary visual display 216 could be a dedicated unit. The multipurpose display 200 may include an app so that an operator may use a tablet, a smartphone, or other electronic device with a display as an auxiliary visual display 216. The auxiliary visual display 216 may be configured to be easily repositioned for each operator of a tractor and/or moved from one tractor to another tractor. In some embodiments, a display device that is already located on the tractor may be utilized as an auxiliary visual display 216. The cost of including an auxiliary visual display 216 may be minimized if utilizing a tablet, a smartphone, and/or a display device that the operator already owns or is already located on the tractor, for example. In other embodiments, the auxiliary visual display 216 may be a heads-up display which may minimize the obstruction of the operator's field of view from the tractor cab. Generally, a heads-up display projects an image onto a transparent surface, such as a tractor cab window, which an operator can see through in addition to seeing the projected image. In some embodiments a heads-up display may project an image onto a screen on the tractor or a distant surface, such as the side of a semi-trailer, for example. In some embodiments, the operator may wear smart glasses that include a heads-up display.

Locating the auxiliary visual display 216 inside a tractor cab may minimize the potential for damage to the auxiliary visual display 216 since the auxiliary visual display 216 would be protected from the elements. Additionally, the auxiliary visual display 216 would not need to be designed for a heavily contaminated environment if the auxiliary visual display 216 is located inside a tractor cab. Other advantages of locating the auxiliary visual display 216 inside a tractor cab may include improved visibility due to the auxiliary visual display 216 not being muddy, dusty, covered in water, etc. Locating the auxiliary visual display 216 on a tractor, but outside the tractor cab, may minimize the amount of space taken up by screens and controls inside the tractor cab. Locating the auxiliary visual display 216 on the tractor may reduce the vibration of the auxiliary visual display 216, making the auxiliary visual display 216 easier to read.

FIG. 7 is a simplified block diagram of the exemplary grain cart 100 and electronic display device 200. As shown in the illustrative block diagram, the grain cart 100 includes one or more feed gate position sensors 158, load cells 160, speed sensors 162, torque sensors 164, temperature sensors 166, pressure sensors 168, moisture sensors 170, receiving container detection sensors 172, discharge spout position sensors 174, unloading auger conveyor fold position sensors 184, and/or other sensors configured to detect operating conditions of the grain cart. As described above, the feed gate position sensors 158 are configured to detect the positions of one or more feed gates 150a, 150b, 150c, 150d, see FIG. 3, and to send an input signal based on the detected positions. The load cells 160 are configured to detect the weight of the grain cart grain tank 120 and any grain in the grain cart grain tank 120 and to send an input signal based on the detected weight. The speed sensors 162 may be configured to detect the rotational speed of the unloading auger conveyor 132 and/or the horizontal auger 154 and to send an input signal based on the detected speed. The torque sensors 164 may be configured to detect the torque applied to the unloading auger conveyor 132, the horizontal auger 154, and/or the total torque to drive all augers and to send an input signal based on the detected torque. The temperature sensors 166 are configured to detect the operating temperatures of components and/or systems of the grain cart 100 such as pumps, motors, gearboxes, wheel bearings, fluids, and the like, and to send an input signal based on the detected temperatures. The pressure sensors 168 are configured to detect the operating pressures of components and systems of the grain cart 100 such as hydraulic fluid pressure, for example, and to send an input signal based on the detected pressures. The moisture sensors 170 are configured to detect the moisture of the grain in the grain cart 100 and to send an input signal based on the detected moisture. The receiving container detection sensors 172 are configured to detect a receiving container, such as a trailer 30, see FIG. 1, for example, and to send an input signal based on the detected receiving container. The discharge spout position sensors 174 are configured to detect the position and/or orientation of the discharge spout 138 and to send an input signal based on the detected position and/or orientation.

As shown in the block diagram of FIG. 7, the illustrative grain cart 100 includes an electronic cart control device 176, a user interface 178, and a GPS receiver 180. The user interface 178 is operatively coupled to electronic cart control device 176 and the operator uses the user interface 178 to program the electronic cart control device 176 to control various devices and/or systems of the grain cart 100. The GPS receiver 180 is operatively coupled to electronic cart control device 176 and is configured to provide grain cart location information to the electronic cart control device 176.

Referring again to the block diagram of FIG. 7, the electronic display device 200 includes the visual display 202, an auxiliary visual display 204, an electronic display control device 206, a memory device 208, and a user interface 210. The electronic display control device 206 is operatively coupled to the visual display 202 and the auxiliary visual display 204. Outputs of the electronic display control device 206 control the visual display 202 and the auxiliary visual display 204 to provide perceptible visual indications to the operator. The electronic display control device 206 may be integrated into the visual display 202, may be separate from the visual display 202, and/or may be removable from the visual display 202. The memory device 208 may be integrated into the electronic display control device 206, may be separate from the electronic display control device 206, and/or may be removable from the electronic display control device 206. The memory device 208 is operatively coupled to electronic cart control device 176. In some embodiments, the memory device 208 may be integrated into the electronic cart control device 176, may be separate from the electronic cart control device 176, and/or may be removable from the electronic cart control device 176. The memory device 208 may be configured to store program instructions and/or data related to operation of the grain cart 100 and/or electronic display device 200, for example. In some embodiments, the electronic display control device 206 may be integrated into the electronic cart control device 176, may be separate from the electronic cart control device 176, and/or may be removable from the electronic cart control device 176.

The memory device 208 is configured to store program instructions and/or data related to operation of the electronic display device 200 and/or the grain cart 100, for example. The user interface 210 is operatively coupled to electronic display control device 206 and the operator uses the user interface 210 to program the electronic display control device 206 to control various features and functions of the electronic display device 200. In some embodiments, the user interface 210 may be a graphical user interface. In alternate embodiments, the user interface 210 may be any combination of switches, push buttons, or other controls configured to program the electronic display device 200. The user interface 210 may include perceptible indicators, including visual indicators and/or audible indicators. The user interface 210 may be located in a tractor cab, for example.

In some embodiments, the electronic display device 200 may include a transmitter 212 and a receiver 214. The user interface 210 may be a remote device, such as a tablet or other smart device, capable of transmitting and receiving signals, and the transmitter 212 and a receiver 214 allow the user interface 210 and the electronic display control device 206 to communicate wirelessly. Utilizing a transmitter 212 and a receiver 214, the user interface 210 may be easily relocated from one tractor cab to another tractor cab, for example. The user interface 210 may be used by an operator while the operator is standing beside a grain cart 100, for example.

Referring again to the block diagram of FIG. 7, the feed gate position sensors 158, load cells 160, speed sensors 162, torque sensors 164, temperature sensors 166, pressure sensors 168, moisture sensors 170, receiving container detection sensors 172, discharge spout position sensors 174, unloading auger conveyor fold position sensors 184, and/or other sensors are operatively coupled to the electronic cart control device 176 and the electronic display control device 206. The various sensors 158, 160, 162, 164, 166, 168, 170, 172, 174, and 184 provide input signals to the electronic cart control device 176 and the electronic display control device 206. The electronic cart control device 176 receives the input signals from the various sensors 158, 160, 162, 164, 166, 168, 170, 172, 174, and 184 and may use the inputs to control the operation of the grain cart 100, provide perceptible indications, and/or provide other information to the operator. The electronic display control device 206 receives the input signals from the various sensors 158, 160, 162, 164, 166, 168, 170, 172, 174, and 184 and uses the inputs to control the operation of the visual display 202 and the auxiliary visual display 204 to provide perceptible visual indications to the operator.

Referring to FIGS. 4A, 4B, 4C, and 7, the foldable upper auger portion 136 is movably coupled to the lower auger portion 134 with an auger hinge 140. An auger fold actuator 142 is coupled to at least one of the foldable upper auger portion 136 or the auger hinge 140 to control the movement of the foldable upper auger portion 136. The unloading auger conveyor fold position sensor 184 is configured to detect the position of the foldable upper auger portion 136 of the unloading auger conveyor 132 and to send an input signal based on the detected position. For example, the unloading auger conveyor fold position sensor 184 will detect when the foldable upper auger portion 136 is in the unloading position as illustrated in FIGS. 1 and 4C. The unloading auger conveyor fold position sensor 184 may also detect when the foldable upper auger portion 136 is in a storage position as illustrated in FIG. 4A, a field storage position as illustrated in FIG. 4B, or some other position. In this illustrative embodiment, the field storage position reduces folding time during field operations and helps prevent mud and dirt from getting into the movable discharge spout 138. In some embodiments, the unloading auger conveyor fold position sensor 184 may be mounted or integral to the auger fold actuator 142. In some embodiments, the unloading auger conveyor fold position sensor 184 may be mounted on or near the auger hinge 140. The unloading auger conveyor fold position sensor 184 may be a rotary position sensor.

Referring to FIGS. 3, 4A, 4B, and 4C, the orientation of the information displayed on the visual display 202 may be dependent on the orientation of the visual display 202 and/or the position or orientation of the foldable upper auger portion 136. For instance, the orientation of the information displayed on the visual display 202 may change so that the information is displayed in an orientation that easily observed and understood by the grain cart operator. For example, alphanumeric characters may always be displayed right side up. In some embodiments, the visual display 202 may include a sensor, such as an inertial measurement unit, for example, to detect an orientation of the visual display 202. The orientation of the information displayed on the visual display 202 may be dependent on the detected orientation of the visual display 202. In other instances, information displayed on the visual display 202 may be dependent on the position or orientation of the foldable upper auger portion 136 of the unloading auger conveyor 132. For example, gate information may not be not shown or may be dimmed when the foldable upper auger portion 136 is folded for transport as the operator typically would not move the gates 150a, 150b, 150c, 150d when not unloading grain unless the operator forgot to close the gates 150a, 150b, 150c, 150d. In some embodiments, the electronic display device 200 may alert the operator that the gates 150a, 150b, 150c, 150d are not fully closed when foldable upper auger portion 136 is folded. The electronic cart control device 176 may automatically close the gates 150a, 150b, 150c, 150d when foldable upper auger portion 136 is folded.

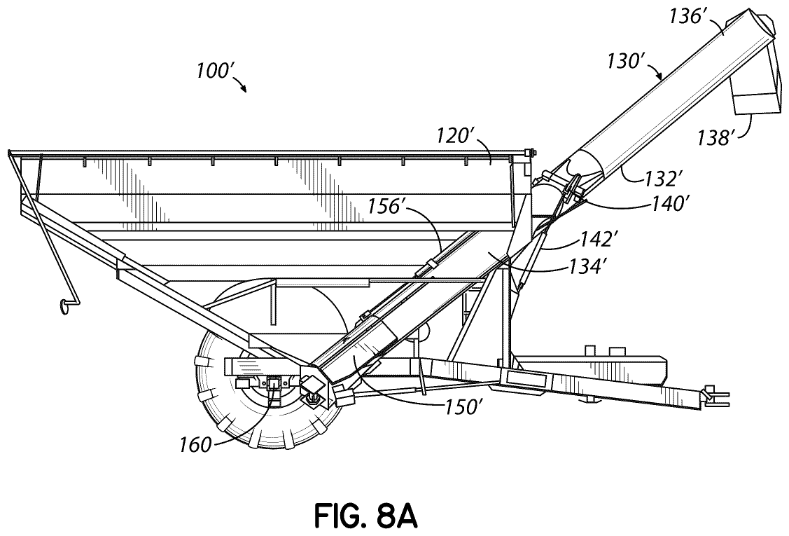

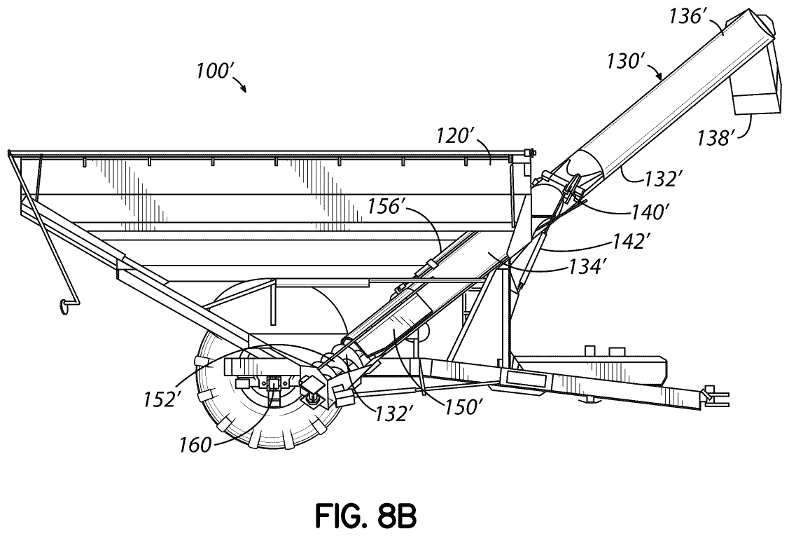

FIG. 8A is a sectional side view of an illustrative single auger corner auger grain cart 100′ with a feed gate 150′ in a closed position. FIG. 8B is a sectional side view of the grain cart 100′ with the feed gate 150′ in at least a partially open position.

Grain cart 100′ is similar in construction and operation to grain cart 100 with the obvious elimination of the horizontal auger. Any feature of the grain cart 100′ may be used in various other exemplary embodiments according to the present disclosure. For brevity, the following description minimizes redundant description and focuses on the differences between the grain cart 100′ and other grain carts described herein. The grain cart 100′ includes a grain tank 120′, a grain transfer element 130′, and an electronic display device 200. The grain transfer element 130′ includes an unloading auger conveyor 132′ including a lower auger portion 134′, a foldable upper auger portion 136′, and a movable discharge spout 138′. The grain transfer element 130′ is configured to transfer grain from the grain cart grain tank 120′ to a receiving container such as grain hopper trailer 40, for example. The grain cart 100′ includes a movable feed gate 150′ configured to cover opening 152′ over the lower auger portion 134′. The feed gate 150′ is positioned by actuator 156′. In this illustrative embodiment, the actuator 156′ is a hydraulic cylinder. In alternate embodiments, the actuator 156′ may be any combination of elements configured to position the feed gate 156′. A position sensor 158 detects the position of the feed gate 150′. The position of the feed gate 150′ determines how much of the opening 152′ is uncovered which controls the amount of grain going to the grain transfer element 130′.

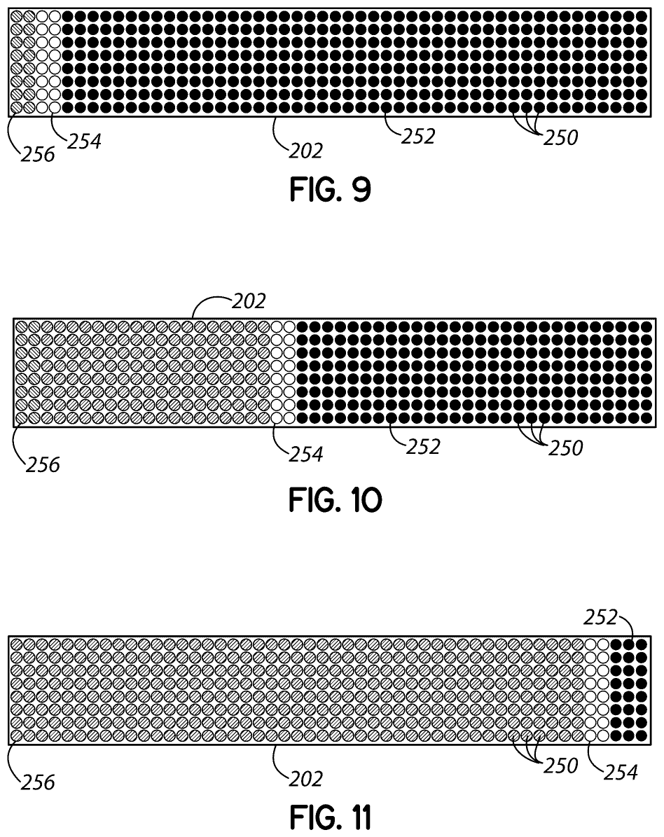

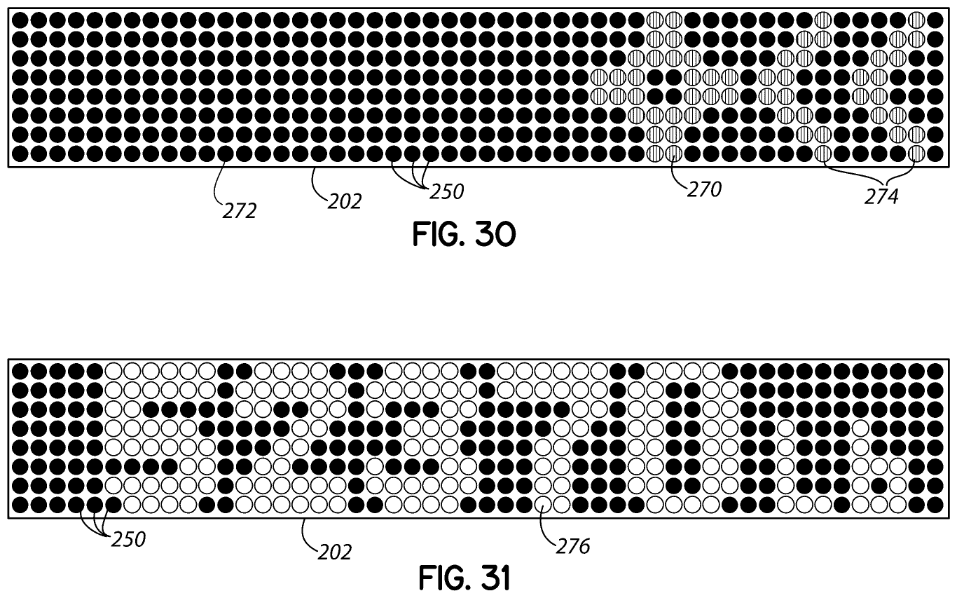

FIGS. 9 through 32 illustrate the visual display 202 providing information, feedback, instructions, and the like, to an operator through the selective use of colors, characters, symbols, or other static or moving indicia. In this illustrative embodiment, the visual display 202 is an (8) eight×(48) forty-eight matrix display with a total of (384) multicolored elements 250, see FIG. 9. In some embodiments, the display may include monochrome elements which may display various tones of only one color. Current grain cart feed gate LED displays are have a single or double row of (5) five to (8) eight LEDs. By providing an (8) eight×(48) forty-eight matrix display, as shown in this illustrative embodiment, the resolution is increased from (5) five to (8) eight steps of resolution to (48) forty-eight steps of resolution. For best visibility under most light conditions, the display and the multicolored elements 250 are black or dark gray when the elements 250 are not energized but may be any color or combination of colors that provide(s) a visible contrast to the elements 250 when they are energized. In this illustrative embodiment, each of the elements 250 are configured to selectively display a plurality of colors as described herein. The visual display 202 is configured to display characters, such as letters and numbers, and symbols, for example, by energizing various combinations of the elements 250. In some embodiments, the visual display 202 may be an LED display. In other embodiments, the visual display 202 may be an E-INK display, a liquid crystal display (LCD), an incandescent display, a plasma display, or other similar display. In some embodiments, the visual display 202 may be a matrix display, such as an LED dot matrix display, for example. In this illustrative embodiment, the visual display 202 may be programmed to display graphics and messages. The visual display 202 may be configured to be used as a work light. The characters and colors of the visual display 202 described herein are for illustrative purposes only and other symbols and/or colors may be used to provide feedback and/or instructions to the operator. These colors and/or characters may also be set by the user according to their preference. The display may also have the ability to change the orientation of the displayed characters and colors based on the orientation of the display to improve the ease of reading the display during certain conditions (i.e. the auger is in the folded position).

Referring to FIGS. 3, 7, and 8B, in some embodiments, the operator manually controls the position of the feed gates 150a, 150b, 150c, 150d, 150′ to control the grain unload or transfer rate. The operator may also use the user interface 178 to control the position of the feed gates 150a, 150b, 150c, 150d, 150′. In some embodiments, the operator uses the user interface 178 to program an electronic cart control device 176 which controls the position of the feed gates 150a, 150b, 150c, 150d, 150′. For example, the operator may program a target feed gate position into the electronic cart control device 176. During an unloading operation the feed gate position sensors 158 provide input signals to the electronic cart control device 176. If the electronic cart control device 176 determines that the feed gates 150a, 150b, 150c, 150d, 150′ are not at the target feed gate position, the electronic cart control device 176 will control the movement of the feed gates 150a, 150b, 150c, 150d, 150′ moving the feed gates 150a, 150b, 150c, 150d, 150′ to the target feed gate position. If the electronic cart control device 176 determines that the feed gates 150a, 150b, 150c, 150d, 150′ are at target feed gate position, the electronic cart control device 176 will stop the movement of the feed gates 150a, 150b, 150c, 150d, 150′. If the user desires to change the target feed gate position during unloading, the user may adjust the target feed gate position with the user interface 178. The electronic cart control device 176 may provide a perceptible indication that the feed gates 150a, 150b, 150c, 150d, 150′ have been closed.

In some embodiments, the operator may program a grain transfer or unload rate into the electronic cart control device 176 which positions the feed gates 150a, 150b, 150c, 150d, 150′ to achieve the programmed grain unload rate. During an unloading operation the feed gate position sensors 158 provide input signals to the electronic cart control device 176. If the electronic cart control device 176 determines that the feed gates 150a, 150b, 150c, 150d, 150′ are not at a position to achieve the programmed grain unload rate, the electronic cart control device 176 will control the movement of the feed gates 150a, 150b, 150c, 150d, 150′ moving the feed gates 150a, 150b, 150c, 150d, 150′ to a position to achieve the programmed grain unload rate. If the electronic cart control device 176 determines that the feed gates 150a, 150b, 150c, 150d, 150′ are in a position to achieve the programmed grain unload rate, the electronic cart control device 176 will stop the movement of the feed gates 150a, 150b, 150c, 150d, 150′. If the user desires to change the grain unload rate during unloading, the user may adjust the grain unload rate with the user interface 178.

Referring again to FIGS. 3, 7, and 8B, in some embodiments, the electronic cart control device 176 includes a cleanout mode. For example, near the end of a grain transfer operation, the electronic cart control device 176 may position the feed gates 150a, 150b, 150c, 150d, 150′ fully open, to enhance discharging all of the grain from the grain cart grain tank 120, 120′. The electronic cart control device 176 may position the feed gates 150a, 150b, 150c, 150d, 150′ fully closed at the end of a cleanout cycle to prevent grain from getting into the augers the next time the grain cart 100, 100′ is filed. In some embodiments, the electronic cart control device 176 may partially close the feed gates 150a, 150b, 150c, 150d, 150′ at specific grain weight or grain volume levels to minimize the time to discharge the final portion of grain from the grain tank 120, 120′. While it is often desirable to fully open the feed gates 150a, 150b, 150c, 150d, 150′ while emptying the grain tank 120, 120′, it may be advantageous to partially close the feed gates 150a, 150b, 150c, 150d, 150′ as the grain level drops below the openings 152a, 152b, 152c, 152d, 152′ to minimize “popcorning,” a condition where grain is kicked out of the openings 152a, 152b, 152c, 152d, 152′ by the augers 132, 154, 132′.

FIGS. 9 through 32 show the visual display 202 in various operational modes described herein. The illuminated colors described herein are for illustrative purposes only to provide examples of how the display may appear to an operator. Contrasting colors may enhance operator visibility of the information on the visual display 202. Any of the various functions of the operational modes described herein may be combined in any combination depending on the configuration of the agricultural implement and/or the needs of the operator. It should be understood that the features of the electronic display device 200 are not limited to the specific illustrative embodiments discussed herein.

FIGS. 9 through 11 show the visual display 202 in an illustrative feed gate position mode and providing a visual indication of the position of the feed gates 150a, 150b, 150c, 150d, 150′, see FIGS. 3 and 8B, to assist the operator with the positioning of the feed gates 150a, 150b, 150c, 150d, 150′. When in the feed gate position mode, the visual display 202 provides a visual representation of the progressive movement of feed gates 150a, 150b, 150c, 150d, 150′ moving from an almost fully closed position, see FIG. 9, to an approximately half open position, see FIG. 10, to an almost fully open position, see FIG. 11. Referring to FIG. 9, in this illustrative embodiment, when the elements 250 of the visual display 202 are not energized they appear black or dark gray. When the visual display 202 is providing a visual indication of the position of the feed gates 150a, 150b, 150c, 150d, 150′, the unenergized portion of the visual display 202 appears black or dark gray and is a feed gate indication 252. The feed gate indication 252 represents the feed gates 150a, 150b, 150c, 150d, 150′. A bar 254, two elements wide, illustrated here in white, represents the leading edge of the feed gates 150a, 150b, 150c, 150d, 150′ and may be illuminated in amber, for example. The remainder of the elements, illustrated here in hatch, are an opening indication 256 representing the portion of the openings 152a, 152b, 152c, 152d, 152′ not covered by the feed gates 150a, 150b, 150c, 150d, 150′ and may be illuminated in dark orange, for example. When the bar 254 is at or near the left side of the visual display 202, the feed gates 150a, 150b, 150c, 150d, 150′ are in a fully closed position, i.e. the feed gates 150a, 150b, 150c, 150d, 150′ are completely covering the openings 152a, 152b, 152c, 152d, 152′. When the bar 254 is at or near the right side of the visual display 202, the feed gates 150a, 150b, 150c, 150d, 150′ are in a fully open position, i.e. the openings 152a, 152b, 152c, 152d, 152′ are completely uncovered or are uncovered as much as possible based on the travel limits of the feed gates 150a, 150b, 150c, 150d, 150′. As the feed gates 150a, 150b, 150c, 150d, 150′ are opened and closed, the colors of the elements 250 change providing a visual representation of the movement, including the direction of movement, of the feed gates 150a, 150b, 150c, 150d, 150′. The visual display 202 provides the operator with an indication that the feed gates 150a, 150b, 150c, 150d, 150′ are opening or closing. The increased resolution of the (8) eight×(48) forty-eight matrix display in this illustrative embodiment enables the operator to more quickly discern which direction the feed gates 150a, 150b, 150c, 150d, 150′ are moving as it takes less time to move 1/48 of the total movement than it does ⅛ of the total movement, for example. In other words, the (48) forty-eight step resolution matrix display will change in ⅙ of the time of an (8) eight step resolution display, giving the operator a much faster indication of which direction the feed gates 150a, 150b, 150c, 150d, 150′ are moving.

As stated above, current grain cart feed gate LED displays have a single or double row of (5) five to (8) eight LEDs. By providing an (8) eight×(48) forty-eight matrix display, as shown in this illustrative embodiment, the resolution is increased from (5) five to (8) eight steps of resolution to (48) forty-eight steps of resolution. The improved resolution of the visual display 202 provides the operator a greater ability to “fine tune” the positions of the feed gates 150a, 150b, 150c, 150d, 150′, see FIGS. 3 and 8B, which directly relates to the grain unloading rate during a grain transfer operation. The visual display 202 may be configured to display a percentage of the opening 154 uncovered by feed gates 150a, 150b, 150c, 150d, 150′ between 0% and 100%, for example. The visual display 202 may be configured to display a grain unloading rate. The visual display 202 may be configured to display an error message if there is a fault in the operation or function of the feed gates 150a, 150b, 150c, 150d, 150′. A feed gate fault could include loss of signal from the feed gate position sensors 158, loss of control of the position actuators 156a, 156b, 156c, 156′, feed gates 150a, 150b, 150c, 150d, 150′ that do not respond to operator input, and similar feed gate related issues. The visual display 202 is configured to display operating instructions which may include messages instructing the operator to open or close the feed gates 150a, 150b, 150c, 150d, 150′, for example. Operating instructions may include instructions to start or stop a grain transfer operation. Operating instructions may include instructions to increase or decrease a tractor PTO speed. While the figures generally illustrate the visual display 202 in a horizontal or landscape orientation, the visual display 202 may be oriented in a generally vertical or portrait orientation, or any other orientation.

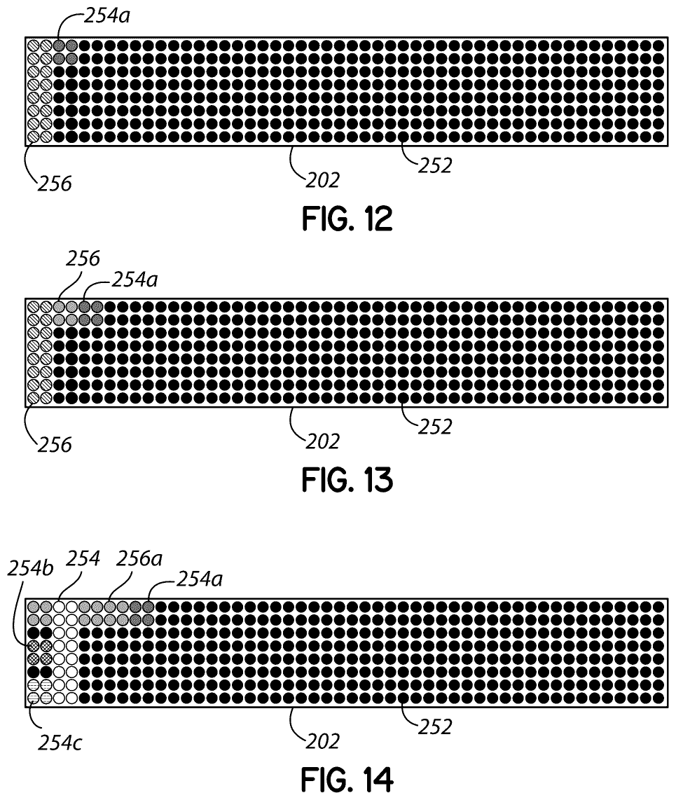

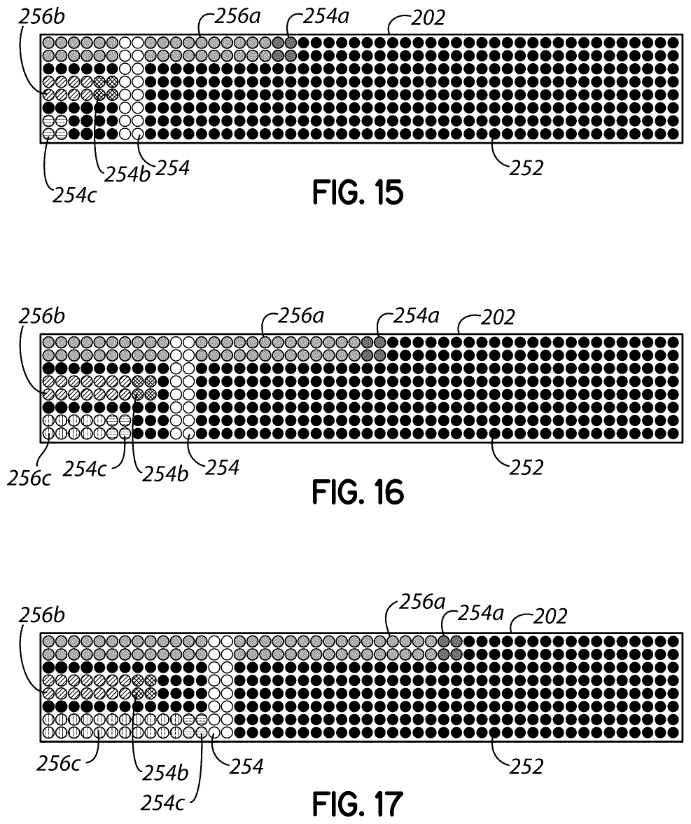

FIGS. 12 through 17 illustrate the visual display 202 in an alternative feed gate position mode on a grain cart 100 with a plurality of feed gates 150a, 150b, 150c, see FIG. 3. In this illustrative embodiment, the visual display 202 provides a visual indication of the position of the feed gates 150a, 150b, 150c, to assist the operator with the positioning of the feed gates 150a, 150b, 150c. When in the alternative feed gate position mode, the visual display 202 provides a visual representation of the progressive movement of the feed gates 150a, 150b, 150c respectively covering and uncovering openings 152a, 152b, 152c. The visual display 202 shows the feed gates 150a, 150b, 150c moving from an almost fully closed position, see FIG. 12, to an approximately half open position, see FIG. 15, to an almost fully open position, see FIG. 17. When the visual display 202 is providing a visual indication of the position of the feed gates 150a, 150b, 150c, the unenergized portion of the visual display 202 appears appear black or dark gray and is a feed gate indication 252. The feed gate indication 252 represents the feed gates 150a, 150b, 150c. A bar 254a two elements wide and two elements high illuminated in red, for example, represents the position of the first gate 150a. A bar 254b two elements wide and two elements high, illustrated here in diagonal cross hatch, represents the position of the second gate 150b and may be illuminated in yellow, for example. A bar 254c two elements wide and two elements high, illustrated here in horizontal hatch, represents the position of the third gate 150c and may be illuminated in purple, for example. A bar 254 two elements wide and eight elements high, illustrated here in white, represents the total gate position and may be illuminated in amber, for example. The number of bars 254a, 254b, 254c may be increased or decreased depending on the number of gates 150a, 150b, 150c. Additionally, each bar 254a, 254b, 254c may represent multiple gates 150a, 150b, 150c. For instance, a display may have two bars 254a, 254b each representing two gates.

A first opening indication 256a, two elements high, illustrated here in medium gray, represents the portion of the first opening 152a not covered by the first feed gate 150a and may be illuminated in dark red, for example. A second opening indication 256b, two elements high, illustrated here in diagonal hatch, represents the portion of the second opening 152b not covered by the second feed gate 150b and may be illuminated in dark yellow, for example. A third opening indication 256c, two elements high, illustrated here in vertical hatch, represents the portion of the third opening 152c not covered by the third feed gate 150c and may be illuminated in dark purple, for example. The number of opening indications 256a, 256b, 256c may be increased or decreased depending on the number of openings 152a, 152b, 152c. Additionally, each opening indication 252a, 252b, 252c may represent multiple openings 152a, 152b, 152c. For instance, a display may have two opening indications 252a, 252b each representing two openings.

When the bars 254a, 254b, 254c are at or near the left side of the visual display 202, the feed gates 150a, 150b, 150c are in a fully closed position, i.e. the feed gates 150a, 150b, 150c are completely covering the openings 152a, 152b, 152c. As the bars 254a, 254b, 254c move to the right side of the visual display 202, the feed gates 150a, 150b, 150c open, i.e. portions of the openings 152a, 152b, 152c are uncovered. As the feed gates 150a, 150b, 150c are opened and closed, the colors of the multicolored elements 250 change providing a visual representation of the movement, including the direction of movement, of the feed gates 150a, 150b, 150c. The visual display 202 provides the operator with an indication that the feed gates 150a, 150b, 150c are opening or closing.

As the feed gates 150a, 150b, 150c are opened, the bar 254 representing the total gate position moves to the right, proportionally representing the total of the openings 152a, 152b, 152c that are uncovered. As the feed gates 150a, 150b, 150c are closed, the bar 254 representing the total gate position moves to the left. For example, if the first feed gate 150a is open 100%, and the second and third gates 152b, 152c are 0% open, the total gate position would be approximately 33%. If the feed gates 150a, 150b, 150c are all open 100%, the total gate position would show 100%.

In some embodiments, a bar 254, may represent a grain throughput. For example, if the first and third gates 152a, 152c are open 100% and the second gate is 0% open, the grain cart 100 may be unloading at 50% of the maximum unloading rate. At the 50% unloading rate, the bar 254 would indicate a 50% unloading rate to the operator.

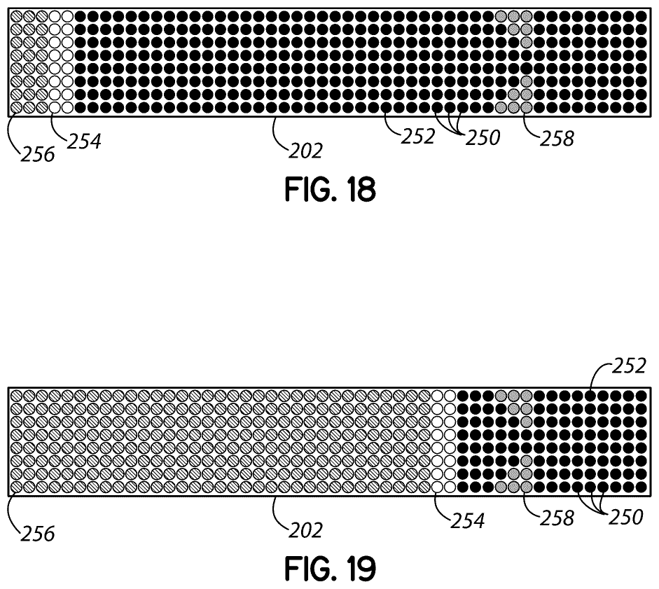

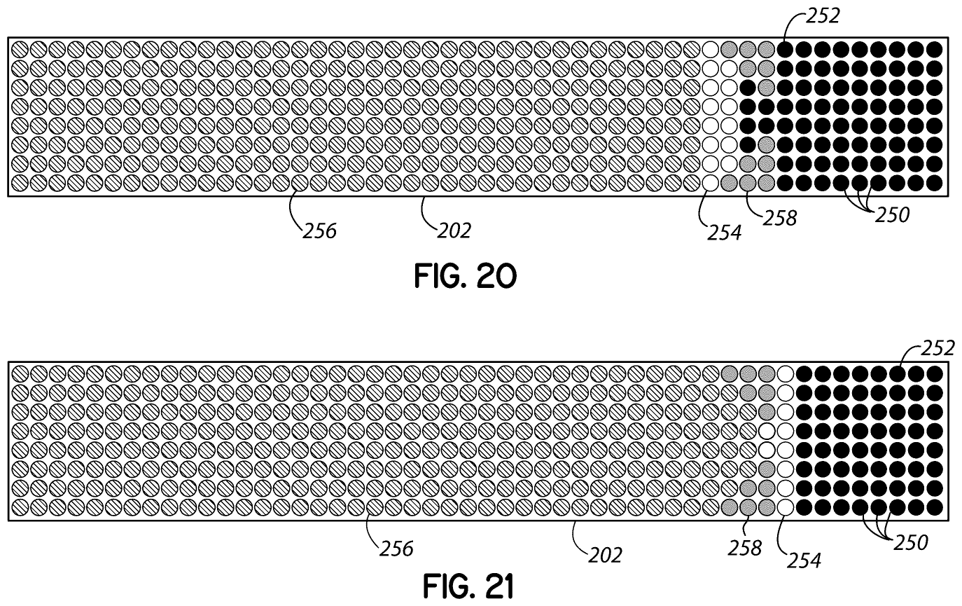

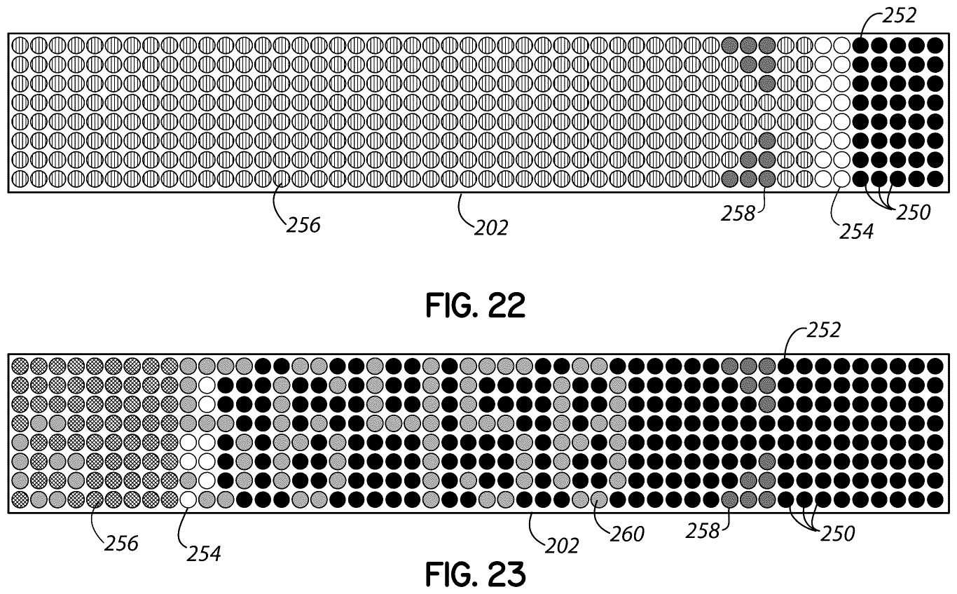

FIGS. 18 through 22 illustrate the visual display 202 in a feed gate target position mode and providing feed gate position feedback to the operator, to assist the operator with the positioning of the feed gates 150a, 150b, 150c, 150d, 150′, see FIGS. 3 and 8B. In this illustrative embodiment, a target feed gate position 258, illustrated here in dark gray, is added to the feed gate indication 252, the bar 254, and the opening indication 256 described above and may be illuminated in blue, for example. The target feed gate position 258 may be programmed by the operator with the user interface 210. The target feed gate position 258 provides a visual target for consistent grain unloading rates from one grain transfer operation to the next. The target feed gate position 258 allows the operator to consistently transfer grain at an unloading rate the operator is comfortable with. While the feed gate position is to the left of the target feed gate position, the bar 254 may be illuminated in amber and the opening indication 256 may be illuminated dark orange, for example, see FIGS. 18 and 19. While the feed gate position is within a preset tolerance of the target feed gate position 258, the bar 254 may change to light green and the opening indication 256 may change to dark green, for example, indicating the feed gates 150a, 150b, 150c are at or very close to the operator's target feed gate position 258, see FIGS. 20 and 21. If the feed gates 150a, 150b, 150c, 150d, 150′ are opened beyond the target feed gate position 258, the bar 254 may change to bright red and the opening indication 256 may change to dark red, for example, see FIG. 22. These color changes give the operator quick and intuitive feedback to maintain or adjust the feed gate position. When interfaced with the electronic cart control device 176, the electronic cart control device 176 could limit the operator's ability to open the feed gates 150a, 150b, 150c, 150d, 150′ beyond the target feed gate position. This allows the operator to open the feed gates 150a, 150b, 150c, 150d, 150′ to the same position consistently even if the operator attempts to open the feed gates 150a, 150b, 150c, 150d, 150′ further than the target feed gate position. At any time during a grain transfer operation, the operator can move the feed gates 150a, 150b, 150c, 150d, 150′ between the fully closed and target open position.

Referring to FIGS. 3, 8B, and 7, the electronic cart control device 176 may be configured to measure and/or control the rate at which grain is unloaded from a supplying container, such as a grain cart grain tank 120, 120′, by incorporating load cells 160 coupled to the grain cart 100, 100′ and the electronic cart control device 176, for example. The load cells 160 are configured to detect the weight of the grain in the grain cart grain tank 120, 120′. The load cells 160 provide an input signal to the electronic cart control device 176 to assist with measuring and/or controlling the unload rate. A transfer rate may be programmed into the electronic cart control device 176. The electronic cart control device 176 is configured to direct the operation of the actuators 156a, 156b, 156c, 156d, 156′ and the directed operation of the actuators 156a, 156b, 156c, 15d, 56′ may be based at least in part on the programmed transfer rate and the weight of the grain in the grain cart grain tank 120. The electronic cart control device 176 monitors the weight of the grain in the grain cart grain tank 120, 120′ and the electronic cart control device 176 may control the position of the feed gates 150a, 150b, 150c, 150d, 150′ to maintain the unload rate at or near the programmed transfer rate.

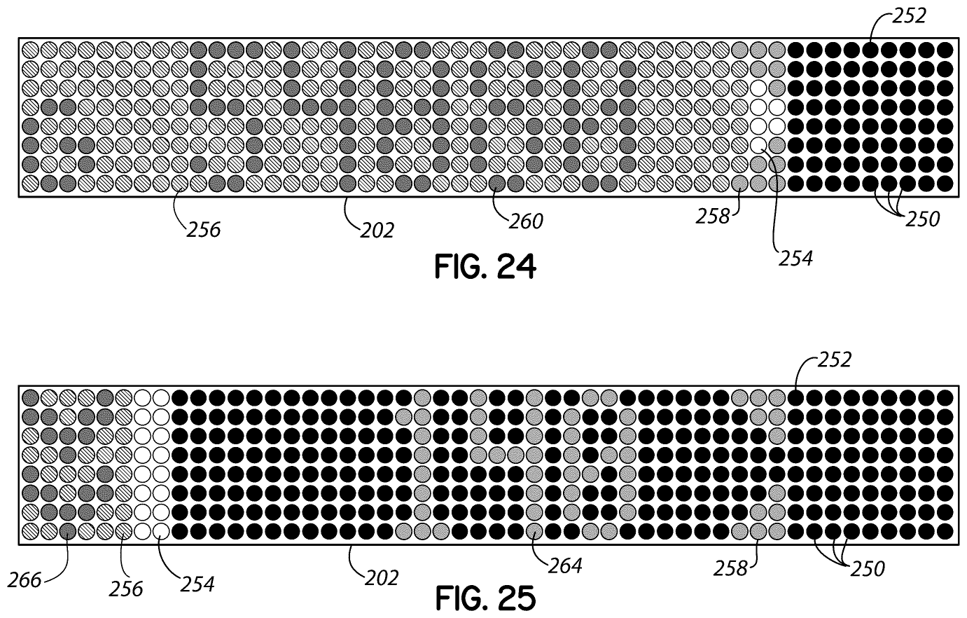

FIGS. 23 and 24 illustrate the visual display 202 in a gross grain weight mode and providing weight information to the operator, to assist the operator with a grain transfer operation. When the visual display 202 is installed on a grain cart 100, see FIG. 4C, equipped with a scale or load cells 160, the weight 260 of the grain in the cart 100 can be overlaid on the visual display 202. FIGS. 23 and 24 show a weight of the grain in the cart 100, illustrated here in medium gray, displayed over a feed gate position indication. The weight displayed in FIG. 24, G 54080, is less than the weight displayed in FIG. 23, G 56450, indicating grain has been unloaded from the cart 100. Alternatively, an operator can monitor the weight of the grain as the grain is loaded into the cart 100 from a harvester, for example. The weight of the grain provides a measurement of the amount of grain in the cart 100 and remaining capacity of the cart 100. The operator makes decisions to stay in their current location, return to the combine, or unload the cart 100 based on the weight of grain in the cart 100. Traditionally, the operator would have a scale display in the tractor cab or on the front wall of the cart. To see the weight of the grain in the cart 100, the operator would need to move their attention away from the area of operation, the discharge spout 138 of the cart 100 and focus their attention on the display. With the visual display 202, the operator's focus remains in the operation area while the visual display 202 provides valuable real time information. Additionally, the auxiliary display 204 may display the weight of the grain in the cart 100 to assist a combine operator transferring grain to the grain cart 100, for example. The visual display 202 and/or the auxiliary display 204 may be configured to display a volume of the grain. The visual display 202 may be configured to display a programmed weight. The programmed weight may be a weight of grain to be transferred to a receiving container or a weight of grain to be transferred to the grain cart 100, for example. The programmed weight may be a weight of grain to be transferred to a portion of a receiving container. The auxiliary visual display 204 may also be used to display messages to a combine operator. For instance, if the feed gates 150a, 150b, 150c, 150d, see FIG. 3, were left open and the load cells 160 started sensing weight being added to the cart, the auxiliary visual display 204 could display a warning to the combine operator that the feed gates 150a, 150b, 150c, 150d are open. This would allow the combine operator to stop unloading into the grain cart 100 and notify the grain cart operator to close the feed gates 150a, 150b, 150c, 150d. The visual display 202 and/or auxiliary visual display 216 on the tractor 10, see FIG. 6A, could also display this warning, however when a grain cart 100 is being loaded, the operator's focus is typically on the grain being loaded into the grain cart 10 and not primarily directed to the visual displays (although the operator may periodically check the loaded weight).

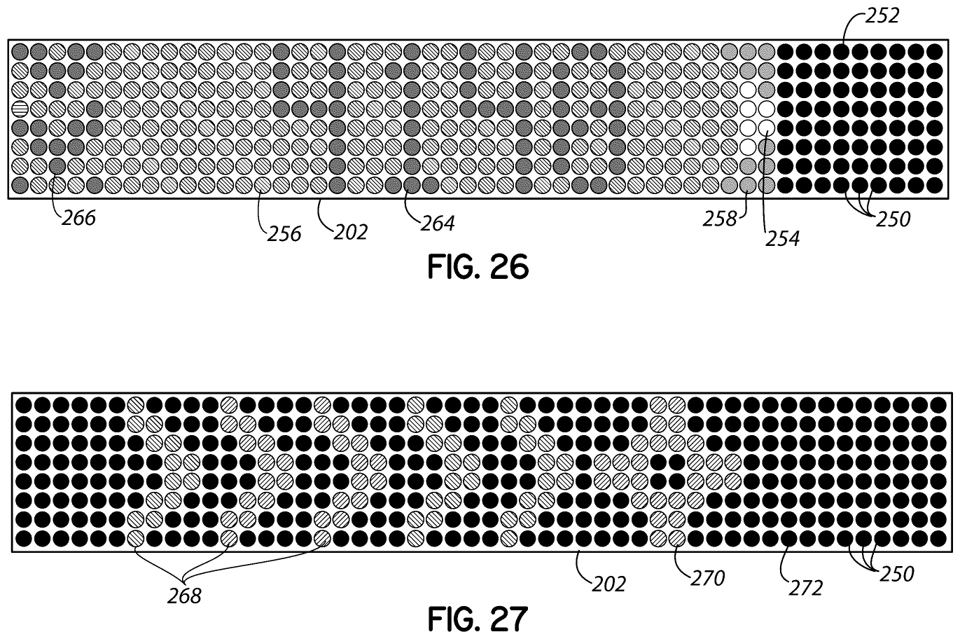

FIGS. 25 and 26 illustrate the visual display 202 in an unloaded grain weight mode during a grain transfer operation and providing weight information to the operator. During a grain transfer operation, the visual display 202 may display the weight 264 of the grain transferred to the receiving container, such as a trailer 30, see FIG. 1. The operator may use the weight 264 of the grain transferred to the receiving container, illustrated here in medium gray, to determine when to stop the grain transfer to prevent overfilling the receiving container. This is helpful for keeping the weight of a grain trailer 30 at or under legal weight limits, for example. The weight displayed in FIG. 26, 4140 is greater than the weight displayed in FIG. 25, 140, indicating grain has been transferred to the receiving container. At the far left of the visual display 202, animated chevrons 266, illustrated here in dark gray, may be illuminated in blue, for example, move down the visual display 202 to give visual feedback to the operator that the grain cart 100 is unloading. This confirms to the operator that the system is functioning and the amount of grain being unloaded is being recorded, such as in one or more memory devices 208, for example. The amount of grain unloaded may be reported to the operator, for example.

FIGS. 27 through 30 illustrate the visual display 202 in a grain cart position assist mode during a grain transfer operation and providing guidance to the operator, to assist the operator with the positioning of the grain cart 100 and discharge spout 138, see FIG. 1. When unloading a grain cart 100, the correct position of the grain cart's discharge spout 138 over the receiving container, like a grain hopper trailer 30, is necessary to ensure the trailer 30 is filled. Each grain transfer operation includes the potential for operator error. For example, the grain cart 100 and discharge spout 138 may be positioned such that the grain is not discharged into the receiving container. Grain that does not end up in the receiving container is lost revenue for the farmer.

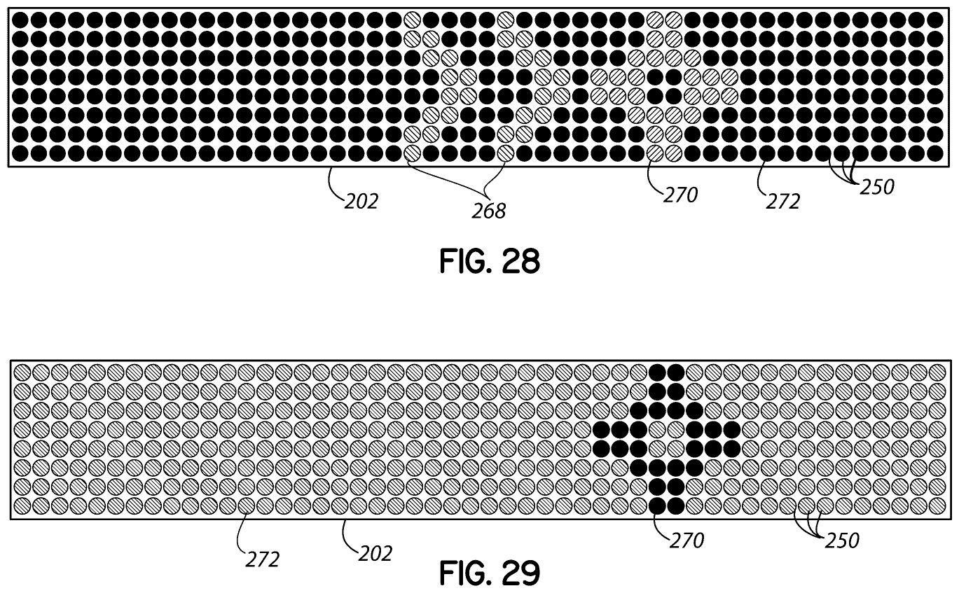

In some embodiments, the grain cart 100 may be equipped with one or more receiving container detection sensors 172, see FIGS. 1 and 7, that are configured to detect the walls of the trailer 30, partitions or compartments in the trailer 30, and/or the grain in the trailer 30, for example. For reference, see U.S. patent application Ser. No. 18/107,147. When the sensors 172 are within range of and able to detect the features of the trailer 30, the sensors 172 send a signal to the electronic cart control device 176 and/or the electronic display control device 206. FIG. 27 shows the visual display 202 with a plurality of directional arrows 268 pointing toward a location target 270. In this example, the background 272 is black or dark gray, the directional arrows 268, illustrated here in diagonal hatch, may be illuminated in amber, for example, and indicate the grain cart 100 must travel forward to align the discharge spout 138 with a portion of the trailer 30 to be filled, the receiving container target area, represented by location target 270. During this portion of the grain unloading operation, the location target 270, also illustrated here in diagonal hatch, may also be illuminated in amber, for example. As the grain cart 100 travels forward and the discharge spout 138 approaches the receiving container target area, the number of arrows 268 is reduced, see FIG. 28. The number of arrows 268 provides a visual indication to the operator of the relative position of the discharge spout 138 to the receiving container target area. When the discharge spout 138 is over the receiving container target area, the background 272 may change to green, for example, and the location target 270 may change to black, for example, to indicate the discharge spout 138 is correctly positioned. If the operator allows the grain cart 100 to travel too far, the background 272 may change to black and the location target 270 may change to red, for example, and a series of opposite facing arrows 274, illuminated in red, for example, instructs the operator to reverse the grain cart's direction of travel to reposition the discharge spout 138 over the receiving container target area. If the discharge spout 138 is correctly positioned above the target area for longer than a pre-determined dwell time, the visual display 202 may revert to the previous feed gate indication mode, see FIGS. 9 through 11 and 12 through 16. When the target area of the trailer 30 has been filed, the visual display 202 may alert the operator to reposition the grain cart 100 to position the discharge spout 138 over the next receiving container target area using the same method as described above. The visual display 202 may alert the operator to stop an unloading operation to prevent overfilling any portion of a receiving container. At the end of an unloading operation, the visual display 202 may instruct the operator to fold the upper auger portion 136 to prevent damage when the grain cart 100 is moved, such as across a field for example. The visual display 202 may display a message to the operator to let the operator know that the grain cart 100 is ready for movement across a field and/or over the road travel.

In this illustrative embodiment, the grain cart 100 is equipped with a movable discharge spout 138, see FIG. 1. The discharge spout 138 is configured for tilting movement on a substantially horizontal axis which is substantially parallel to a side wall of the grain cart 100 from a generally downward discharge direction to an outward discharge direction. The discharge spout 138 is also configured for tilting movement on a substantially horizontal axis which is substantially perpendicular to a side wall of the grain cart 100 from a generally forward discharge direction to a generally rearward discharge direction. The alignment and movement of the discharge spout 138 improves the ability of an operator to fill the trailer 30, including all four corners. Similar to the positioning issues described above, when operating a grain cart 100 with a movable discharge spout 138, it is possible to orient the discharge spout 138 so that the grain is not discharged into the receiving container. The grain cart 100 may be equipped with one or more discharge spout position sensors 174, see FIG. 7. The discharge spout position sensors 174 are configured to detect the position and/or orientation of the discharge spout 138 and to send an input signal based on the detected position and/or orientation to the electronic cart control device 176 and/or the electronic display control device 206. The visual display 202 may provide visual indications, similar to those shown in FIGS. 27 through 30, during a grain transfer operation, to assist the operator with moving the grain cart 100 and/or moving and/or orienting the discharge spout 138. For example, the visual display 202 may provide instructions to the operator to move the grain cart 100 forward, backward, toward the receiving container, or away from the receiving container. The visual display 202 may provide instructions to the operator to move or orient the discharge spout 138 forward, backward, toward the grain cart, or away from the grain cart to fill the receiving container target area of the trailer 30. The visual display 202 may display at least one of a position or orientation of the discharge spout 138.

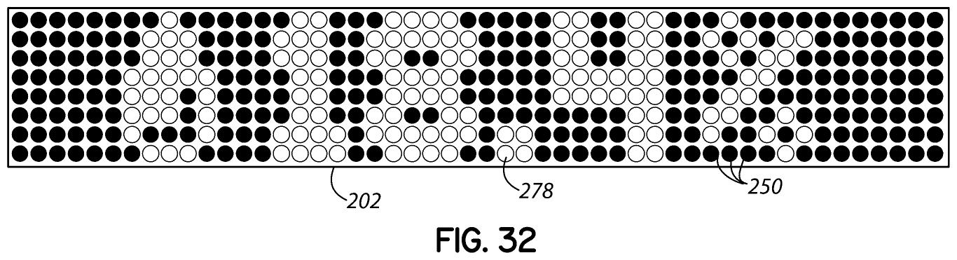

FIGS. 31 through 32 illustrate the visual display 202 in an end of unload summary mode after a grain transfer operation and providing information about the unloaded grain to the operator. When the grain transfer operation is complete, the visual display 202 shows the weight of the unloaded grain 276, see FIG. 31, and the moisture of the unloaded grain 278, see FIG. 32. The visual display 202 may display other summary information. The operator could customize the visual display 202 to include information such as field name, commodity (i.e. type of grain), total unload weight from a single or multiple grain transfer operations, grain trailer identifier or destination identifier, or any other useful or identifying information. As stated above, the GPS receiver 180 is operatively coupled to electronic cart control device 176 and is configured to provide grain cart location information to the electronic cart control device 176, see FIG. 7. The visual display 202 may be configured to display location coordinates and/or a field name or a location name based on the grain cart location.

Referring to FIGS. 3, 7, and 8B, in alternative embodiments, the electronic cart control device 176 may be configured to monitor and/or maintain a rotational speed of an unloading auger conveyor 132, 132′ and/or a horizontal auger 154, for example. In some applications, the grain unload rate may be controlled by controlling the rotational speed of the unloading auger conveyor 132, 132′ and/or the horizontal auger 154, for example. A speed sensor 162 may provide input signals to the electronic cart control device 176 and/or the electronic display control device 206. The visual display 202 may be configured to display the rotational speed of the unloading auger conveyor 132, 132′ and/or the horizontal auger 154. The electronic cart control device 176 may control the position of the feed gates 150a, 150b, 150c, 150d, 150′ to control the rotational speed of the unloading auger conveyor 132, 132′ and/or horizontal auger 154, for example. The electronic cart control device 176 may control other devices on the grain cart 100, 100′ to control the rotational speed of the unloading auger conveyor 132, 132′ and/or horizontal auger 154. If the electronic cart control device 176 determines that the rotational speed of the unloading auger conveyor 132, 132′ and/or the horizontal auger 154 is too low, an operator may be alerted to increase the speed of the tractor's PTO by a message on the visual display 202, for example. The electronic cart control device 176 may be configured to not open the feed gates 150a, 150b, 150c, 150d, 150′ if the detected rotational speed is below a minimum value, for example. The electronic cart control device 176 may provide a message on the visual display 202 that the electronic cart control device 176 will not open the feed gate 150a, 150b, 150c, 150d, 150′ due to low rotational speed.

In some embodiments, the electronic cart control device 176 may be configured to monitor and maintain the torque applied to an unloading auger conveyor 132, 132′ and/or a horizontal auger 154 below a maximum torque value. Farm equipment, including tractors and grain carts generally include torque limiting devices to prevent damage to the equipment. If the applied torque exceeds a maximum torque value, the torque limiting device will be activated to prevent damage. The torque sensor 164 is configured to detect an applied torque and provide an input signal to the electronic cart control device 176 and/or the electronic display control device 206. The visual display 202 may be configured to display the torque applied to the unloading auger conveyor 132, 132′ and/or the horizontal auger 154. As the rotational speed of an auger, for example, decreases the operational torque may increase. In some embodiments, the grain cart unloading auger conveyor 132, 132′ and/or the horizontal auger 154 may be operated at an optimal rotational speed, thereby minimizing the operational torque and stresses on the grain cart unloading system and minimizing the chance that a torque limiting device on the unloading system will be activated. If the electronic cart control device 176 determines that the applied torque is approaching the maximum torque value because the rotational speed of the unloading auger conveyor 132, 132′ and/or the horizontal auger 154 is too low, an operator may be alerted by a message on the visual display 202 to increase the speed of the tractor's PTO, for example. If a torque limiting device on the unloading system is activated, the electronic cart control device 176 may provide a message on the visual display 202 that the torque limiting device has been activated. In some embodiments, the electronic cart control device 176 may control the position of the feed gates 150a, 150b, 150c, 150d, 150′ to maintain the torque applied to the unloading auger conveyor 132, 132′ and/or the horizontal auger 154 below the maximum torque value.

Referring to FIGS. 3, 7, and 8B, a minimum torque value may be an indication that there is little or no grain in the grain transfer element 130, 130′, for example. The electronic cart control device 176 may close the feed gates 150a, 150b, 150c, 150d, 150′ if the detected torque is below a minimum torque value. Automatically closing the feed gates 150a, 150b, 150c, 150d, 150′ based on a detected torque value may save the operator the additional step of closing the feed gates 150a, 150b, 150c, 150d, 150′ after grain unloading is complete, for example. The electronic cart control device 176 may provide a message on the visual display 202 that the feed gates 150a, 150b, 150c, 150d, 150′ have been closed.

In alternative or additional aspects, the electronic cart control device 176 may be configured to control the horsepower applied to the unloading auger conveyor 132, 132′ and/or the horizontal auger 154. As described above, the torque sensor 164 and the speed sensor 162 provide input signals to the electronic cart control device 176. The electronic cart control device 176 may calculate the horsepower based on the input signals, for example. Alternately, the horsepower applied to the unloading auger conveyor 132, 132′ and/or the horizontal auger 154 may be detected by a single sensor, for example. The visual display 202 may be configured to display the horsepower applied to the unloading auger conveyor 132, 132′ and/or the horizontal auger 154. The electronic cart control device 176 may be programmed to control the position of the feed gates 150a, 150b, 150c, 150d, 150′ to control the applied horsepower. A maximum horsepower may be set below a maximum operating horsepower of the tractor 10 so as not to stall the tractor engine, for example.

Referring again to the block diagram of FIG. 7, the exemplary grain carts 100, 100′ include temperature sensors 166, pressure sensors 168, and/or other sensors configured to detect operating conditions of the grain carts. As described above, the temperature sensors 166 are configured to detect the operating temperatures of components and/or systems of the grain cart 100 such as pumps, motors, gearboxes, wheel bearings, fluids, and the like, and to send an input signal based on the detected temperatures. The visual display 202 may be configured to display the operating temperatures. The pressure sensors 168 are configured to detect the operating pressures of components and systems of the grain carts 100, 100′ such as hydraulic fluid pressure, for example, and to send an input signal based on the detected pressures. The visual display 202 may be configured to display the operating pressures. The electronic cart control device 176 and/or the electronic display control device 206 may be configured to record a number of operating cycles, such as grain transfer operations, for example. The visual display 202 may be configured to display at least one of a remaining lubricant life, operating hours, or an unload count. As used herein, lubricant may include oil, grease, or any other lubricant. Remaining lubricant life may be based on temperatures, pressures, operating hours, operating cycles, and other operating conditions, for example. In some embodiments, the visual display 202 may be configured to display at least one of a warning, an error code, a troubleshooting code, a troubleshooting instruction, a calibration instruction, a maintenance reminder, or contact information.

A method of operating an electronic display device 200 for a grain cart 100, 100′, or other agricultural implement, includes detecting an operating condition of the grain cart 100, 100′ and displaying information related to the detected operating condition that is viewable by an operator of the grain cart 100 during a grain transfer operation. The method may include displaying operating instructions. The method may include displaying at least one of a rotational speed, a torque, or a horsepower.

Referring to FIGS. 1 and 8A, a method of manufacturing an electronic display device 200 for a grain cart 100, 100′, or other agricultural implement, includes providing a visual display 202, configured to display grain cart information, and mounting the visual display 202 on the grain transfer element 130, 130′. The visual display 202 should be mounted on the grain transfer element 130, 130′ such that the visual display 202 is viewable by an operator of the grain cart 100, 100′ during a grain transfer operation. The visual display 202 is configured to display information related to one or more detected operating conditions of the grain cart 100, 100′. Referring to FIG. 7, the visual display 202 may be operably coupled to one or more feed gate position sensors 158, load cells 160, speed sensors 162, torque sensors 164, temperature sensors 166, pressure sensors 168, moisture sensors 170, receiving container detection sensors 172, discharge spout position sensors 174, unloading auger conveyor fold position sensors 184, and/or other sensors. The visual display 202 may be configured to display at least one of a rotational speed, a torque, or a horsepower. The visual display 202 may be configured to display at least one of a grain transfer or unload rate, a load rate, a grain moisture content, a load time, an unload time, a weight, an unloaded weight, a volume, or an unloaded volume. The visual display 202 may be operably coupled to the electronic cart control device 176 and/or the electronic display control device 206. The visual display 202 may be configured to display at least one of a remaining lubricant life, operating hours, or an unload count. The visual display 202 may be configured to display at least one of a warning, an error code, a troubleshooting code, a troubleshooting instruction, a calibration instruction, a maintenance reminder, or contact information. The visual display 202 may be configured to display operating instructions. The visual display 202 may be configured to display operational settings. The visual display 202 may be configured to display at least one of a field name, equipment name, or a location.

It should be understood that the electronic display device 200 may be used with or installed on other agricultural implements, such as seed tenders, for example. Specifically, and/or in addition to the display options discussed herein, an electronic display device 200 used with or installed on a seed tender may be configured to display weight, unload weight, seed tender door opening, settings, for example, or other information or instructions. The electronic display device 200 may be used with any agricultural implement whose operation may benefit from having a visual display 202 that me be viewed by an operator of the agricultural implement during the operation of the agricultural implement.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The invention in its broader aspects is therefore not limited to the specific details, representative apparatus and methods and illustrative examples illustrated and described. Accordingly, departures may be made from such details without departing from the scope or spirit of the general inventive concept.

1. An electronic display device comprising:
a visual display operably coupled to one or more sensors on a grain cart;
wherein the visual display is mounted on a grain transfer element of the grain cart, the visual display is configured to be viewable by an operator of the grain cart during a grain transfer operation, and the visual display is configured to display at least one of grain cart information or operating instructions.

2. The electronic display device of claim 1, wherein the visual display is configured to display at least one of a rotational speed, a torque, or a horsepower.

3. The electronic display device of claim 1, wherein the visual display is configured to display at least one of an unload rate, a moisture content, an unload time, a weight, an unloaded weight, a volume, or an unloaded volume.

4. The electronic display device of claim 1, wherein the visual display is configured to display at least one of a remaining lubricant life, operating hours, a load count, or an unload count.

5. The electronic display device of claim 1, wherein the visual display is configured to display at least one of a warning, an error code, a troubleshooting code, a troubleshooting instruction, a calibration instruction, a maintenance reminder, or contact information.

6. The electronic display device of claim 1, wherein the visual display comprises at least one of an LED display, an E-INK display, a liquid crystal display (LCD), an incandescent display, a plasma display, a matrix display, or a multicolor display.

7. The electronic display device of claim 1, wherein the visual display is configured to display at least one of letters, numbers, or symbols.

8. The electronic display device of claim 1, wherein the visual display is programmable to display graphics or messages.

9. The electronic display device of claim 1, wherein the visual display is configured to be used as a work light.

10. The electronic display device of claim 1, wherein at least one of the sensors is a feed gate position sensor,
wherein the electronic display device is operably coupled to the feed gate position sensor, and
wherein the visual display is configured to display a feed gate position.

11. The electronic display device of claim 10, wherein the visual display is configured to display at least one of a direction the feed gate is moving, if the feed gate is opening or closing, if the feed gate is fully open or fully closed, or a percentage of the opening of the feed gate from 0% to 100%.

12. The electronic display device of claim 10, wherein the visual display is configured to display a programmed feed gate position, and
wherein the visual display is configured to display the feed gate position relative to the programmed feed gate position.

13. The electronic display device of claim 10, wherein the visual display is configured to display an error in at least one of an operation or function of a feed gate.

14. The electronic display device of claim 10, wherein the operating instructions include at least one of positioning the feed gate, opening the feed gate, or closing the feed gate.

15. The electronic display device of claim 1, wherein at least one of the sensors is a scale or load cell constructively configured to measure a weight of material in the grain cart,
wherein the electronic display device is operably coupled to the scale or load cell, and
wherein the visual display is configured to display the weight of the material in the grain cart.

16. The electronic display device of claim 1, wherein at least one of the sensors is a scale or load cell constructively configured to measure a weight of material in the grain cart,
wherein the electronic display device is operably coupled to the scale or load cell, and
wherein the visual display is configured to display a weight of material transferred to a receiving container.

17. The electronic display device of claim 1, wherein the operating instructions include at least one of starting or stopping a grain transfer operation.

18. The electronic display device of claim 1, wherein the operating instructions include at least one of increasing or decreasing a rotational speed.

19. The electronic display device of claim 1, wherein the visual display is operably coupled to a sensor that is constructively configured to detect the orientation of the visual display, and
wherein the orientation of at least one of the grain cart information or the operating instructions displayed on the visual display is based at least in part on the detected orientation of the visual display.

20. The electronic display device of claim 1 further comprising an auxiliary visual display operably coupled to the one or more sensors on the grain cart;
wherein the auxiliary visual display is configured to be viewable by an operator of the grain cart during a grain transfer operation and to display at least one of grain cart information or operating instructions.

21. The electronic display device of claim 20, wherein the auxiliary visual display is at least one of a tablet computer, a smartphone, a monitor, or a heads-up display.

22. The electronic display device of claim 20, wherein the auxiliary visual display is mounted on a tractor.

23. The electronic display device of claim 20, wherein at least one of the sensors is a feed gate position sensor,
wherein the electronic display device is operably coupled to the feed gate position sensor, and
wherein the auxiliary visual display is configured to display a feed gate position.

24. The grain cart of claim 23, wherein the auxiliary visual display is configured to display at least one of a direction the feed gate is moving, if the feed gate is opening or closing, if the feed gate is fully open or fully closed, or a percentage of the opening of the feed gate from 0% to 100%.

25. The electronic display device of claim 23, wherein the auxiliary visual display is configured to display a programmed feed gate position, and
wherein the visual display is configured to display the feed gate position relative to the programmed feed gate position.

26. The electronic display device of claim 23,
wherein the auxiliary visual display is configured to display an error in at least one of an operation or function of a feed gate.

27. The electronic display device of claim 23, wherein the operating instructions include at least one of positioning the feed gate, opening the feed gate, or closing the feed gate.

28. A grain cart comprising:
a grain cart container configured to hold grain;
a grain transfer element configured to transfer grain from the grain cart container to a receiving container;
a feed gate configured to selectively control a transfer rate of the grain;
a feed gate position sensor configured to detect a position of the feed gate; and
an electronic display device operatively coupled to the feed gate position sensor, the electronic display device including a visual display mounted on the grain cart and configured to display a feed gate position and at least one of grain cart information or operating instructions, and the visual display is viewable by an operator of the grain cart during a grain transfer operation.

29. The grain cart of claim 28, wherein the visual display is mounted on the grain transfer element.

30. The grain cart of claim 28, wherein the visual display is configured to display at least one of a direction the feed gate is moving, if the feed gate is opening or closing, if the feed gate is fully open or fully closed, or a percentage of the opening of the feed gate from 0% to 100%.

31. The grain cart of claim 28, wherein the visual display is configured to display a programmed feed gate position and to display the feed gate position relative to the programmed feed gate position.

32. The grain cart of claim 28, wherein the visual display is configured to display an error in at least one of an operation or function of the feed gate.

33. The grain cart of claim 28, wherein the visual display is configured to display at least one of a rotational speed, a torque, or a horsepower.

34. The grain cart of claim 28, wherein the visual display is configured to display at least one of an unload rate, a moisture content, an unload time, a weight, an unloaded weight, a volume, or an unloaded volume.

35. The grain cart of claim 28, wherein the visual display is configured to display at least one of a remaining lubricant life, operating hours, a load count, or an unload count.

36. The grain cart of claim 28, wherein the visual display is configured to display at least one of a warning, an error code, a troubleshooting code, a troubleshooting instruction, a calibration instruction, a maintenance reminder, or contact information.

37. The grain cart of claim 28, wherein the visual display comprises at least one of an LED display, an E-INK display, a liquid crystal display (LCD), an incandescent display, a plasma display, a matrix display, or a multicolor display.

38. The grain cart of claim 28, wherein the visual display is configured to display at least one of letters, numbers, or symbols.

39. The grain cart of claim 28, wherein the visual display is programmable to display graphics or messages.

40. The grain cart of claim 28, wherein the visual display is configured to be used as a work light.

41. The grain cart of claim 28, further comprising a scale or load cell constructively configured to measure a weight of material in the grain cart,
wherein the electronic display device is operably coupled to the scale or load cell, and
wherein the visual display is configured to display the weight of the material in the grain cart.

42. The grain cart of claim 28, further comprising a scale or load cell constructively configured to measure a weight of material in the grain cart,
wherein the visual display is configured to display a weight of material transferred to a receiving container.

43. The grain cart of claim 28, wherein the operating instructions include at least one of positioning the feed gate, opening the feed gate, or closing the feed gate.

44. The grain cart of claim 28, wherein the operating instructions include at least one of starting or stopping a grain transfer operation.

45. The grain cart of claim 28, wherein the operating instructions include at least one of increasing or decreasing a rotational speed.

46. The grain cart of claim 28, wherein the operating instructions include instructions for moving the grain cart to change the position of the grain transfer element relative to a receiving container.

47. The grain cart of claim 28, wherein the visual display is operably coupled to a sensor that is constructively configured to detect the orientation of the visual display, and
wherein the orientation of information displayed on the visual display is based at least in part on the detected orientation of the visual display.

48. A method of operating an electronic display device with a visual display mounted on a grain transfer element of a grain cart, the method comprising:
detecting an operating condition of the grain cart; and
displaying information related to the detected operating condition on the visual display that is viewable by an operator of the grain cart during a grain transfer operation.

49. The method of claim 48, further comprising displaying operating instructions.

50. The method of claim 48, further comprising displaying at least one of a rotational speed, a torque, or a horsepower.

51. The method of claim 48, further comprising displaying at least one of an unload rate, a moisture content, an unload time, a weight, an unloaded weight, a volume, or an unloaded volume.

52. The method of claim 48, further comprising displaying at least one of a remaining lubricant life, operating hours, or an unload count.

53. The method of claim 48, further comprising displaying at least one of a warning, an error code, a troubleshooting code, a troubleshooting instruction, a calibration instruction, a maintenance reminder, or contact information.

54. A method of manufacturing an electronic display device, the method comprising:
providing a visual display configured to display grain cart information;
operably coupling the visual display to a sensor; and
mounting the visual display on a grain cart grain transfer element;
wherein the visual display is viewable by an operator of the grain cart during a grain transfer operation.

55. The method of claim 54, wherein the visual display is configured to display information related to a detected operating condition of the grain cart.

56. The method of claim 54, wherein the visual display is configured to display at least one of a rotational speed, a torque, or a horsepower.

57. The method of claim 54, wherein the visual display is configured to display at least one of an unload rate, a moisture content, an unload time, a weight, an unloaded weight, a volume, or an unloaded volume.

58. The method of claim 54, wherein the visual display is configured to display at least one of a remaining lubricant life, operating hours, or an unload count.

59. The method of claim 54, wherein the visual display is configured to display at least one of a warning, an error code, a troubleshooting code, a troubleshooting instruction, a calibration instruction, a maintenance reminder, or contact information.

60. The method of claim 54, wherein the visual display is configured to display operating instructions.
